(19) United States
(12) Patent Application Publication
(10) Pub. No.: US 2014/0079135 A1
(43) Pub. Date: Mar. 20, 2014

(54) PERFORMING QUANTIZATION TO FACILITATE DEBLOCKING FILTERING

(71) Applicant: QUALCOMM Incoporated, San Diego, CA (US)

(72) Inventors: Geert Van der Auwera, San Diego, CA (US); Rajan Laxman Joshi, San Diego, CA (US); Marta Karczewicz, San Diego, CA (US)

(73) Assignee: QUALCOMM Incoporated, San Diego, CA (US)

(21) Appl. No.: 14/025,094

(22) Filed: Sep. 12, 2013

Related U.S. Application Data
(60) Provisional application No. 61/701,518, filed on Sep. 14, 2012.
(60) Provisional application No. 61/704,842, filed on Sep. 24, 2012.
(60) Provisional application No. 61/707,741, filed on Sep. 28, 2012.

(51) Int. Cl. H04N 7/26

(52) U.S. Cl. CPC H04N 19/00909
USPC 375/240.18; 375/240.29

(57) ABSTRACT

A method of encoding video data includes encoding a quantization parameter delta value in a coding unit (CU) of the video data before coding a version of a block of the CU in a bitstream so as to facilitate deblocking filtering. Coding the quantization parameter delta value may comprise coding the quantization parameter delta value based on the value of a no_residual_syntax flag that indicates whether no blocks of the CU have residual transform coefficients.

This application claims priority to U.S. Provisional Application No. 61/701,518, filed on Sep. 14, 2012, U.S. Provisional Application No. 61/704,842, filed on Sep. 24, 2012, and U.S. Provisional Application No. 61/707,741, filed on Sep. 28, 2012, the entire content of each of which is incorporated herein by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for signaling of a coding unit quantization parameter delta syntax element that may facilitate low-delay deblocking filtering. When coding video data, boundaries between blocks of coded video data may exhibit blockiness artifacts, which a video coder may reduce using a variety of deblocking techniques. Current video coding techniques may introduce a high delay between receiving an encoded video block, and determining the quantization parameter for the encoded video block. A quantization parameter delta is used to reconstruct the encoded video block before the video coder performs deblocking. Thus, the high delay in determining the quantization parameter for the encoded block reduces the speed at which an encoded block may be deblocked, which hurts decoding performance. The techniques of this disclosure include techniques for signaling a quantization parameter delta value to more quickly determine the quantization parameter of a block during video decoding. Some techniques of this disclosure may code syntax elements, including the quantization parameter delta value based on whether a residual sample block of a TU has a coded block flag equal to one, indicating that the residual sample block has at least one residual transform coefficient.

In one example, this disclosure describes a method comprising encoding a quantization parameter delta value in a coding unit (CU) of the video data before encoding a version of a block of the CU in a bitstream, so as to facilitate deblocking filtering.

In another example, this disclosure describes a method of decoding video data, the method comprising decoding a quantization parameter delta value in a coding unit (CU) of the video data before decoding a version of a block of the CU in a bitstream, so as to facilitate deblocking filtering and means for performing deblocking filtering on the block of the CU.

In another example, this disclosure describes a device configured to code video data, the device comprising a memory; and at least one processor, wherein the at least one processor is configured to code a quantization parameter delta value in a coding unit (CU) of the video data before coding a version of a block of the CU in a bitstream, so as to facilitate deblocking filtering.

In another example, this disclosure describes a device for coding video, the device comprising means for encoding a quantization parameter delta value in a coding unit (CU) of the video data before encoding a version of a block of the CU in a bitstream, so as to facilitate deblocking filtering.

In another example, this disclosure describes a In another example, this disclosure describes a non-transitory computer-readable storage medium comprising instructions that, when executed by at least one processor, cause the at least one processor to encode a quantization parameter delta value in a coding unit (CU) of the video data before encoding a version of a block of the CU in a bitstream, so as to facilitate deblocking filtering.

In another example, this disclosure describes a method of encoding video, the method comprising determining a sub-quantization group, wherein the sub-quantization group comprises one of a block of samples within a quantization group, and a block of samples within a video block with dimensions larger than or equal to a size of the quantization group, and performing quantization with respect to the determined sub-quantization group.

In another example, this disclosure describes a method of decoding video, the method comprising determining a sub-quantization group, wherein the sub-quantization group comprises one of a block of samples within a quantization group, and a block of samples within a video block with dimensions larger than or equal to a size of the quantization group, and performing inverse quantization with respect to the determined sub-quantization group.

In another example, this disclosure describes a device configured to code video data, the device comprising a memory, and at least one processor, wherein the at least one processor is configured to determine a sub-quantization group, wherein the sub-quantization group comprises one of a block of samples within a quantization group, and a block of samples within a video block with dimensions larger than or equal to a size of the quantization group, and perform inverse quantization with respect to the determined sub-quantization group.

In another example, this disclosure describes a device for coding video, the device comprising means for determining a sub-quantization group, wherein the sub-quantization group comprises one of a block of samples within a quantization group, and a block of samples within a video block with dimensions larger than or equal to a size of the quantization group, and means for performing inverse quantization with respect to the determined sub-quantization group.

In another example, this disclosure describes a non-transitory computer-readable storage medium comprising instructions that, when executed by at least one processor, cause the at least one processor to determine a sub-quantization group, wherein the sub-quantization group comprises one of a block of samples within a quantization group, and a block of samples within a video block with dimensions larger than or equal to a size of the quantization group, and perform inverse quantization with respect to the determined sub-quantization group.

In another example, this disclosure describes a method of encoding video, the method comprising determining whether one or more coded block flags, which indicate whether there are any non-zero residual transform coefficients in a block of video data, are equal to zero within blocks of video data of a transform tree based on a split transform flag, and encoding the transform tree for the blocks of video data based on the determination.

In another example, this disclosure describes a method of decoding video, the method comprising determining whether one or more coded block flags, which indicate whether there are any residual transform coefficients in a block of video data, are equal to zero within blocks of video data of a transform tree based on a split transform flag, and decoding the transform tree for the blocks of video data based on the determination.

In another example, this disclosure describes a device configured to code video data, the device comprising a memory, and at least one processor, wherein the at least one processor is configured to determine whether one or more coded block flags, which indicate whether there are any residual transform coefficients in a block of video data, are equal to zero within blocks of video data of a transform tree based on a split transform flag, and code the transform tree for the blocks of video data based on the determination.

In another example, this disclosure describes a device configured to code video data, the device comprising means for determining whether one or more coded block flags, which indicate whether there are any residual transform coefficients in a block of video data, are equal to zero within blocks of video data of a transform tree based on a split transform flag, and means for coding the transform tree for the blocks of video data based on the determination.

In another example, this disclosure describes a non-transitory computer-readable storage medium comprising instructions that, when executed by at least one processor, cause the at least one processor to, determine whether one or more coded block flags, which indicate whether there are any residual transform coefficients in a block of video data, are equal to zero within blocks of video data of a transform tree based on a split transform flag, and code the transform tree for the blocks of video data based on the determination.

In another example, this disclosure describes a method of encoding video data, the method comprising setting a value of a split transform flag in a transform tree syntax of a block of coded video data based on at least one coded block flag that depends from the split transform flag.

In another example, this disclosure describes a device for encoding video, the device comprising a memory, and at least one processor, wherein the at least one processor is configured to set a value of a split transform flag in a transform tree syntax of a block of coded video data based on at least one coded block flag that depends from the split transform flag.

In another example, this disclosure describes a device for encoding video, the device comprising means for setting a value of a split transform flag in a transform tree syntax of a block of coded video data based on at least one coded block flag that depends from the split transform flag and means for performing deblocking filtering on the block of coded video data.

In yet another example, this disclosure describes a non-transitory computer-readable storage medium comprising instructions that, when executed by at least one processor, cause the at least one processor to set a value of a split transform flag in a transform tree syntax of a block of coded video data based on at least one coded block flag that depends from the split transform flag.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram that illustrates an example video encoder 20 that may be configured to implement the techniques of this disclosure.

FIG. 3 is a block diagram illustrating an example of a video decoder that may implement the techniques described in this disclosure.

FIG. 4 is a flowchart illustrating a method for reducing deblocking delay in accordance with an aspect of this disclosure.

FIG. 5 is a flowchart illustrating a method for reducing deblocking delay in accordance with another aspect of this disclosure.

FIG. 6 is a flowchart illustrating a method for reducing deblocking delay in accordance with another aspect of this disclosure.

FIG. 7 is a flowchart illustrating a method for reducing deblocking delay in accordance with another aspect of this disclosure.

### DETAILED DESCRIPTION

In general, this disclosure describes techniques for signaling a coding unit quantization parameter delta syntax element that may facilitate low-delay deblocking filtering. Video coding generally includes steps of predicting a value for a block of pixels, and coding residual data representing differences between a predicted block and actual values for pixels of the block. The residual data, referred to as residual coefficients, may be transformed and quantized, then entropy coded. Entropy coding may include scanning the quantized transform coefficients to code values representative of whether the coefficients are significant, as well as coding values representative of the absolute values of the quantized transform coefficients themselves, referred to herein as the “levels” of the quantized transform coefficients. In addition, entropy coding may include coding signs of the levels.

When quantizing, (which is another way to refer to “rounding”) the video coder may identify a quantization parameter that controls the extent or amount of rounding to be performed with respect to a given sequence of transform coefficients. Reference to a video coder throughout this disclosure may refer to a video encoder, a video decoder or both a video encoder and a video decoder. A video encoder may perform quantization to reduce the number of non-zero transform coefficients and thereby promote increased coding efficiency. Commonly, when performing quantization, the video encoder quantizes higher-order transform coefficients (that correspond to higher frequency cosines, assuming the transform is a discrete cosine transform), reducing these to zero so as to promote more efficient entropy coding without greatly affecting the quality or distortion of the coded video (considering that the higher-order transform coefficients are more likely to reflect noise or other high-frequency, less perceivable aspects of the video).

In some examples, the video encoder may signal a quantization parameter delta, which expresses a difference between a quantization parameter expressed for the current video block and a quantization parameter of a reference video block. This quantization parameter delta may more efficiently code the quantization parameter in comparison to signaling the quantization parameter directly. The video decoder may then extract this quantization parameter delta and determine the quantization parameter using this quantization parameter delta.

A video decoder may likewise perform inverse quantization using the determined quantization parameter in an attempt to reconstruct the transform coefficients and thereby reconstruct the decoded version of the video data, which again may be different from the original video data due to quantization. The video decoder may then perform an inverse transform to transform the inverse quantized transform coefficients from the frequency domain back to the spatial domain, where these inverse transform coefficients represent a decoded version of the residual data. The residual data is then used to reconstruct a decoded version of the video data using a process referred to as motion compensation, which may then be provided to a display for display. As noted above, while quantization is generally a lossy coding operation or, in other words, results in loss of video detail and increases distortion, often this distortion is not overly noticeable by viewers of the decoded version of the video data. In general, the techniques of this disclosure are directed to techniques for facilitating deblocking filtering by reducing the delay of determining a quantization parameter value for a block of video data.

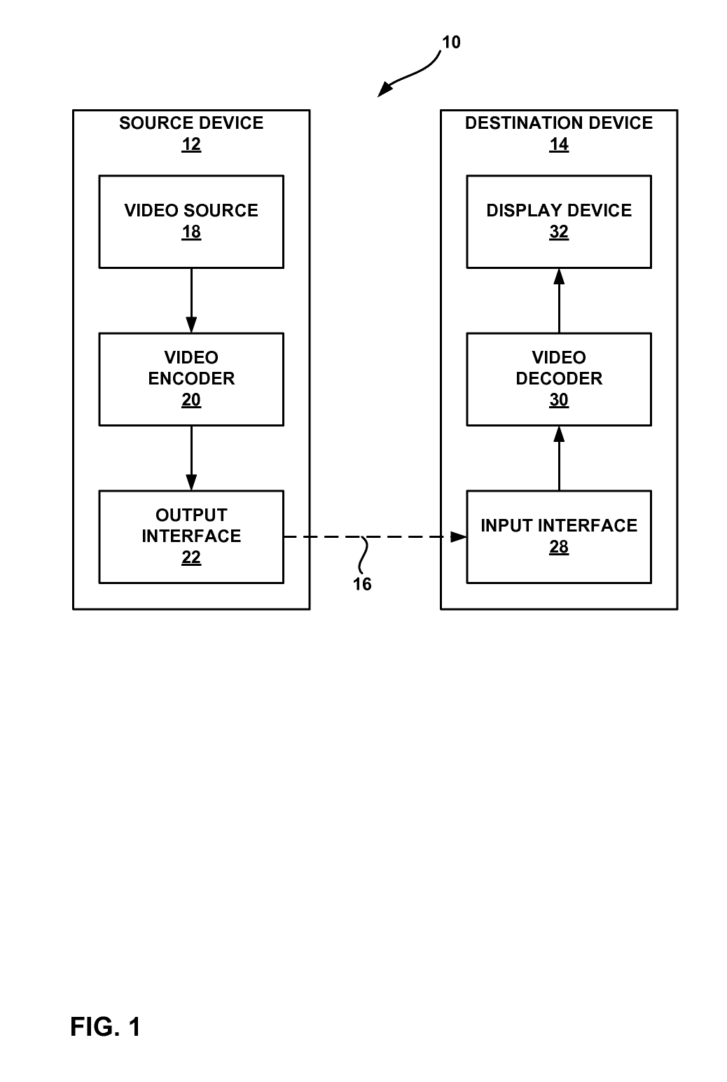

FIG. 1 is a block diagram that illustrates an example video coding system 10 that may utilize the techniques of this disclosure for reducing latency and buffering in deblocking associated with determining quantization parameter delta values of a CU. As used described herein, the term “video coder” refers generically to both video encoders and video decoders. In this disclosure, the terms “video coding” or “coding” may refer generically to video encoding and video decoding.

As shown in FIG. 1, video coding system 10 includes a source device 12 and a destination device 14. Source device 12 generates encoded video data. Destination device 14 may decode the encoded video data generated by source device 12. Source device 12 and destination device 14 may comprise a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, in-car computers, or the like. In some examples, source device 12 and destination device 14 may be equipped for wireless communication.

Destination device 14 may receive encoded video data from source device 12 via a channel 16. Channel 16 may comprise any type of medium or device capable of moving the encoded video data from source device 12 to destination device 14. In one example, channel 16 may comprise a communication medium that enables source device 12 to transmit encoded video data directly to destination device 14 in real-time. In this example, source device 12 may modulate the encoded video data according to a communication standard, such as a wireless communication protocol, and may transmit the modulated video data to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or other equipment that facilitates communication from source device 12 to destination device 14.

In another example, channel 16 may correspond to a storage medium that stores the encoded video data generated by source device 12. In this example, destination device 14 may access the storage medium via disk access or card access. The storage medium may include a variety of locally accessed data storage media such as Blu-ray discs, DVDs, CD-ROMs, flash memory, or other suitable digital storage media for storing encoded video data. In a further example, channel 16 may include a file server or another intermediate storage device that stores the encoded video generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), FTP servers, network attached storage (NAS) devices, and local disk drives. Destination device 14 may access the encoded video data through any standard data connection, including an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1, source device 12 includes a video source 18, video encoder 20, and an output interface 22. In some cases, output interface 22 may include a modulator/demodulator (modem) and/or a transmitter. In source device 12, video source 18 may include a source such as a video capture device, e.g., a video camera, a video archive containing previously captured video data, a video feed interface to receive video data from a video content provider, and/or a computer graphics system for generating video data, or a combination of such sources.

Video encoder 20 may encode the captured, pre-captured, or computer-generated video data. The encoded video data may be transmitted directly to destination device 14 via output interface 22 of source device 12. The encoded video data may also be stored onto a storage medium or a file server for later access by destination device 14 for decoding and/or playback.

In the example of FIG. 1, destination device 14 includes an input interface 28, a video decoder 30, and a display device 32. In some cases, input interface 28 may include a receiver and/or a modem. Input interface 28 of destination device 14 receives encoded video data over channel 16. The encoded video data may include a variety of syntax elements generated by video encoder 20 that represent the video data. Such syntax elements may be included with the encoded video data transmitted on a communication medium, stored on a storage medium, or stored a file server.

Display device 32 may be integrated with or may be external to destination device 14. In some examples, destination device 14 may include an integrated display device and may also be configured to interface with an external display device. In other examples, destination device 14 may be a display device. In general, display device 32 displays the decoded video data to a user. Display device 32 may comprise any of a variety of display devices such as a liquid crystal display (LCD), a plasma display, an organic light emitting diode (OLED) display, or another type of display device.

Video encoder 20 and video decoder 30 may operate according to a video compression standard. Example video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, there is a new video coding standard, namely High-Efficiency Video Coding (HEVC), being developed by the Joint Collaboration Team on Video Coding (JCT-VC) of ITU-T Video Coding Experts Group (VCEG) and ISO/IEC Motion Picture Experts Group (MPEG). In other examples, video encoder 20 and video decoder 30 may operate according to the High Efficiency Video Coding (HEVC) standard presently under development, and may conform to a HEVC Test Model (HM). Another recent draft of the HEVC standard, referred to as “HEVC Working Draft 10” or “WD10,” is described in document JCTVC-L1003v34, Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, CH, 14-23 Jan., 2013, which, as of Jul. 15, 2013, is downloadable from http://phenix.intevryfr/jct/doc_end_user/documents/12_Geneva/wg11/JCTVC-L1003-v34.zip, the entire content of which is incorporated by reference.

Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in the example of FIG. 1, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Again, FIG. 1 is merely an example and the techniques of this disclosure may apply to video coding settings (e.g., video encoding or video decoding) that do not necessarily include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, hardware, or any combinations thereof. When the techniques are implemented partially in software, a device may store instructions for the software in a suitable, non-transitory computer-readable storage medium and may execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

Both video encoder 20 and the video decoder 30 may also perform an operation referred to as deblocking filtering. Given that video data is commonly divided into blocks that, in the emerging high frequency video coding (HEVC) standard, are stored to a node referred to as a coding unit (CU), the video coder (e.g. video encoder 20 or video decoder 30) may introduce arbitrary boundaries in the decoded version of the video data that may result in some discrepancies between adjacent video blocks along the line separating one block from another. More information regarding HEVC can be found in document JCTVC-11003 d7, Bross et al., “High Efficiency Video Coding (HEVC) Text Specification Draft 8,” Joint Collaborative Team on Video Coding (JCT-VC) of ITU-T SG16 WP3 and ISO/IEC JTC1/SC29/WG11, 10^{th} Meeting: Stockholm, Sweden, July 2012, which, as of Sep. 14, 2102, is downloadable from http://phenix.int-evry.fr/jct/doc_end_user/documents/10_Stockholm/wg11/JCTVC-J1003-v8.zip (hereinafter “WD8”). These discrepancies often result in what is termed a “blockiness,” where the various boundaries of blocks used to code the video data become apparent to a viewer, especially when a frame or scene involves a large fairly monochrome background or object. As a result, video encoder 20 and video decoder 30 may each perform deblocking filtering to smooth the decoded video data (which the video encoder may produce for use as reference video data in encoding video data), and particularly the boundaries between these blocks.

Recently, the HEVC standard adopted ways by which to enable CU-level processing. Before this adoption, the transmission of cu_qp_delta (which is a syntax element that expresses a coding unit (CU) level quantization parameter (QP) delta) was delayed until the first CU with coefficients in a quantization group (QG). The cu_qp_delta expresses the difference between a predicted quantization parameter and a quantization parameter used to quantize a block of residual transform coefficients. A QG is the minimum block size where the quantization parameter delta is signaled. A QG may consist of a single CU or multiple CUs. In many instances, the QG may be smaller than one or more possible CU sizes. For example, a QG may be defined and/or signaled to be a size of 16×16 pixels. In some other examples, it would be possible to have CUs of size 32×32 or 64×64.

Transmitting the quantization parameter delta with the first CU having transform coefficients inhibited CU-level decode processing because in some cases, the first CU having transform coefficients may be a CU of a coding tree unit (CTU) that is located near the end of the CTU. Therefore, in such cases, a video decoder must reconstruct the a large amount of the CTU, and wait for the first CTU having transform coefficients before receiving the quantization parameter delta value used to reconstruct and deblock any CUs that come before the first CU having transform coefficients.

In order to avoid inhibited CU-level decode processing, an adopted proposal (which refers to T. Hellman, W. Wan, “Changing cu_qp_delta parsing to enable CU-level level processing,” JCT-VC Meeting, Geneva, Switzerland, April 2012, Doc. JCTVC-10219) notes that a QP value is necessary for deblocking filtering operations, and therefore earlier CUs in the same QG cannot be filtered until cu_qp_delta is received. The adopted proposal changes in the definition of QP within a quantization group such that the delta QP only applies to the CU containing the cu_qp_delta syntax element, and the CUs that come after within the same QG. Any earlier CUs simply use the predicted QP for the QG.

However, in some instances, the adopted proposal fails to adequately solve problems caused by certain coding tree block (CTB) structures that may result in the delay of deblocking filtering. For example, if the CTB has a size of 64×64, the cu_qp_delta_enable_flag is equal to one (which specifies that the diff_cu_qp_delta_depth syntax element is present in the PPS and that the quantization parameter delta value may be present in the transform unit syntax), the diff_cu_qp_delta_depth (which specifies the difference between the luma coding tree block size and the minimum luma coding block size of CUs that convey a quantization parameter delta value) is equal to zero. And if the CU size is equal to 64×64, there are no CU splits, the CU is intra-coded (so all boundary strengths are 2, deblocking will modify pixels). And if the CU has a fully split transform unit (TU) tree, having 256, 4×4 luma sample blocks, and only the last TU of the TU tree has a coded block flag (“cbf,” which indicates whether a block has any non-zero residual transform coefficients) equal to one, decoding the quantization parameter delta value may be inhibited.

In this instance, the CTB has a size of 64×64 and the cu_qp_delta_enabled_flag specifies that the CU-level quantization parameter delta is enabled for this CTB. The CU size is the same size as the CTB, which means that the CTB is not further segmented into two or more CUs, but that the CU is as large as the CTB. Each CU may also be associated with, reference or include one or more prediction units (PUs) and one or more transform units (TUs). The PUs store data related to motion estimation and motion compensation. The TUs specify data related to application of the transform to the residual data to produce the transform coefficients.

A fully split TU tree in the above instance indicates that the 64×64 block of data stored to the full size CU is split into 256 partitions (in this instance for the luma components of video data), where transform data is specified for each of these partitions using 256 TUs. Since the adopted proposal noted above only provides for utilizing a cu_qp_delta if at least one of the TUs has a non-zero transform coefficient, if only the last TU has a coded block flag equal to one (meaning that this block has non-zero transform coefficients), the video encoder and/or the video decoder may only determine that this cu_qp_delta is utilized until coding the last TU. This delay may then impact deblocking filtering as the deblocking filtering must wait until the last TU has been processed, resulting in large latency and buffers.

In accordance with a no residual syntax flag for intra-coded CU aspect of the techniques described in this disclosure, video encoder 20 may signal the quantization parameter value (delta QP) at the beginning of every CU. Signaling the delta QP at the beginning of a CU allows video decoder 30 to avoid the delay associated with having to wait for the delta QP value of a last TU in the cases described above before decoding and deblocking earlier TUs in the CTB.

However, in a case where there is no coded residual data in the CU, signaling the delta QP at the beginning of each CU may represent an additional overhead compared with the proposed HEVC standard syntax. Therefore, video encoder 20 may then signal a no_residual_syntax_flag in such a case to indicate that there is no coded residual data before signaling a delta QP. Video encoder 20 may then signal the delta QP if no_residual_syntax_flag is equal to 0 (i.e. to specify there are no blocks that have a cbf equal to one) or false, or equivalently, there is at least one cbf equal to 1 or true within the CU. As is the case in a proposed version of the HEVC standard, video encoder 20 may signal the delta QP only once per QG.

In one proposal for HEVC syntax, the no_residual_syntax_flag is only signaled for an inter-coded CU that is not 2N×2N type and not merged (merge_flag). Therefore, to support the techniques described in this disclosure, video encoder 20 may signal the no_residual_syntax_flag for an intra-coded CU to signal cu_delta_qp at the beginning of the CU. The video encoder may code the no_residual_syntax_flag using separate or joined contexts for inter- or intra-mode.

The following tables 1 and 2 illustrate changes to one proposal for the HEVC standard syntax. In addition, the following table 3 illustrates changes to the HEVC standard syntax, where if the no_residual_syntax_flag is true for an intra-coded CU, the video encoder may disable signaling of cbf flags for luma and chroma. Lines in the tables below beginning with “@” symbols denote additions in syntax from those specified either in the recently adopted proposal or the HEVC standard. Lines in the tables below beginning with “#” symbols denote removals in syntax from those specified either in the recently adopted proposal or the HEVC standard. As an alternative to signalling the no_residual_syntax_flag for intra-coded CUs, a video encoder may be disallowed from signalling a transform tree for intra-coded CUs if all cbf flags are zero. In this instance, the video encoder may signal the delta QP value at the beginning of the intra-coded CU.

TABLE 1
no_residual_syntax_flag Coding Unit Syntax

| | Descriptor |
|---|---|
| coding_unit( x0, y0, log2CbSize ) { | |
| if( transquant_bypass_enable_flag ) { | |
| cu_transquant_bypass_flag | ae(v) |
| } | |
| if( slice_type != I ) | |
| skip_flag[ x0 ][ y0 ] | ae(v) |
| if( skip flag[ x0 ][ y0 ] ) | |
| prediction_unit( x0, y0, log2CbSize ) | |
| else { | |
| nCbS = ( 1 << log2CbSize ) | |
| if( slice_type != I ) | |
| pred_mode_flag | ae(v) |
| if( PredMode[ x0 ][ y0 ] != MODE_INTRA \| \| log2CbSize = = | |
| Log2MinCbSize ) | |
| part_mode | ae(v) |
| if( PredMode[ x0 ][ y0 ] = = MODE_INTRA ) { | |
| if( PartMode = = PART_2Nx2N && pcm_enabled_flag && | |
| log2CbSize >= Log2MinIPCMCUSize && | |
| log2CbSize <= Log2MaxIPCMCUSize ) | |
| pcm_flag | ae(v) |
| if( pcm_flag ) { | |
| num_subsequent_pcm | tu(3) |
| NumPCMBlock = num_subsequent_pcm + 1 | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_NxN ) ? ( nCbS / 2) : 0 | |
| for( j = 0; j <= pbOffset; j = j + pbOffset ) | |
| for( i = 0; i <= pbOffset; i = i + pbOffset ) { | |
| prev_intra_luma_pred_flag[ x0 + i ][ y0 + j ] | ae(v) |
| } | |
| for( j = 0; j <= pbOffset; j = j + pbOffset ) | |
| for( i = 0; i <= pbOffset; i = i + pbOffset ) { | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| } | |
| intra_chroma_pred_mode[ x0 ][ y0 ] | ae(v) |
| } | |
| } else { | |
| if( PartMode = = PART_2Nx2N ) | |
| prediction_unit( x0, y0, nCbS, nCbS ) | |
| else if( PartMode = = PART_2NxN ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_Nx2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2NxnU ) { | |
| prediction_unit( x0, y0, nCbS, nCbS / 4 ) | |
| prediction_unit( x0, y0 + ( nCbS / 4 ), nCbS, nCbS *3 / 4 ) | |
| } else if( PartMode = = PART_2NxnD ) { | |
| prediction_unit( x0, y0, nCbS, nCbS *3 / 4 ) | |
| prediction_unit( x0, y0 + ( nCbS * 3 / 4 ), nCbS, nCbS / 4 ) | |
| } else if( PartMode = = PART_nLx2N ) { | |
| prediction_unit( x0, y0, nCbS /4, nCbS ) | |
| prediction_unit( x0 + ( nCbS / 4 ), y0, nCbS *3 / 4, nCbS) | |
| } else if( PartMode = = PART_nRx2N ) { | |
| prediction_unit( x0, y0, nCbS *3 / 4, nCbS ) | |
| prediction_unit( x0 + ( nCbS * 3 / 4 ), y0, nCbS / 4, nCbS ) | |
| } else { /* PART_NxN */ | |
| prediction_unit( x0, y0, nCbS / 2, nCbS / 2) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 +( nCbS / 2 ), nCbS / 2, nCbS / 2) | |
| } | |
| } | |
| if( !pcm_flag ) { | |
| # if( PredMode[ x0 ][ y0 ] != MODE_INTRA && | |
| # !(PartMode = = PART_2Nx2N && merge_flag[x0][y0]) ) | |
| @ if( !(PartMode = = PART_2Nx2N && merge_flag[x0][y0]) ) \|\| | |
| @ (MODE_INTRA && cu_delta_qp_enabled) | |
| no_residual_syntax_flag | ae(v) |
| # if( !no_residual_syntax_flag ) { | |
| @ if( !no_residual_syntax_flag \|\| PredMode[ x0 ][ y0 ] == | |
| @ MODE_INTRA) { | |
| MaxTrafoDepth = ( PredMode[ x0 ][ y0 ] = = MODE_INTRA ? | |
| max_transform_hierarchy_depth_intra + | |
| IntraSplitFlag : | |
| max_transform_hierarchy_depth_inter ) | |
| @ if(!no_residual_syntax_flag && cu_qp_delta_enabled_flag && | |
| @ !IsCuQpDeltaCoded ) { | |
| @ cu_qp_delta_abs | ae(v) |
| @ if( cu_qp_delta_abs ) | |
| @ cu_qp_delta_sign | ae(v) |
| @ } | |
| transform_tree( x0, y0 x0, y0, log2CbSize, 0, 0 ) | |
| } | |
| } | |
| } | |
| } | |

TABLE 2
no_residual_syntax_flag Transform Unit Syntax

| | Descriptor |
|---|---|
| transform_unit( x0, y0, xBase, yBase, log2TrafoSize, trafoDepth, blkIdx ) { | |
| if( cbf_luma[ x0 ][ y0 ][ trafoDepth ] \| \| cbf_cb[ x0 ][ y0 ][ trafoDepth ] \| \| | |
| cbf_cr[ x0 ][ y0 ][ trafoDepth ] ) { | |
| # if( cu_qp_delta_enabled_flag && !IsCuQpDeltaCoded ) { | |
| # cu_qp_delta_abs | ae(v) |
| # if( cu_qp_delta_abs ) | |
| # cu_qp_delta_sign | ae(v) |
| # } | |
| if( cbf_luma[ x0 ][ y0 ][ trafoDepth ] ) | |
| residual_coding( x0, y0, log2TrafoSize, 0 ) | |
| if( log2TrafoSize > 2) { | |
| if( cbf_cb[ x0 ][ y0 ][ trafoDepth ] ) | |
| residual_coding( x0, y0, log2TrafoSize, 1 ) | |
| if( cbf_cr[ x0 ][ y0 ][ trafoDepth ] ) | |
| residual_coding( x0, y0, log2TrafoSize, 2 ) | |
| } else if( blkIdx = = 3 ) { | |
| if( cbf_cb[ xBase ][ yBase ][ trafoDepth ] ) | |
| residual_coding( xBase, yBase, log2TrafoSize, 1 ) | |
| if( cbf_cr[ xBase ][ yBase ][ trafoDepth ] ) | |
| residual_coding( xBase, yBase, log2TrafoSize, 2 ) | |
| } | |
| } | |
| } | |

TABLE 3
no_residual_syntax_flag Transform Tree Syntax

| | Descriptor |
|---|---|
| Transform_tree( x0, y0, xBase, yBase, log2TrafoSize, trafoDepth, blkIdx ) | |
| { | |
| if( log2TrafoSize <= Log2MaxTrafoSize && | |
| log2TrafoSize > Log2MinTrafoSize && | |
| trafoDepth < MaxTrafoDepth && !(IntraSplitFlag && trafoDepth | |
| = = 0) ) | |
| split_transform_flag[ x0 ][ y0 ][ trafoDepth ] | ae(v) |
| if( ( trafoDepth = = 0 \| \| log2TrafoSize > 2 ) | |
| @ && !no_residual_syntax_flag ) { | |
| if( trafoDepth = = 0 \| \| cbf_cb[ xBase ][ yBase ][ trafoDepth − 1 ] ) | |
| cbf_cb[ x0 ][ y0 ][ trafoDepth ] | ae(v) |
| if( trafoDepth = = 0 \| \| cbf_cr[ xBase ][ yBase ][ trafoDepth − 1 ] ) | |
| cbf_cr[ x0 ][ y0 ][ trafoDepth ] | ae(v) |
| } | |
| if( split_transform_flag[ x0 ][ y0 ][ trafoDepth ] ) { | |
| x1 = x0 + ( ( 1 << log2TrafoSize ) >> 1 ) | |
| y1 = y0 + ( ( 1 << log2TrafoSize ) >> 1 ) | |
| transform_tree( x0, y0, x0, y0, log2TrafoSize − 1, trafoDepth + 1, 0 ) | |
| transform_tree( x1, y0, x0, y0, log2TrafoSize − 1 trafoDepth + 1, 1 ) | |
| transform_tree( x0, y1, x0, y0, log2TrafoSize − 1, trafoDepth + 1, 2 ) | |
| transform_tree( x1, y1, x0, y0, log2TrafoSize − 1, trafoDepth + 1, 3 ) | |
| } else { | |
| if( ( PredMode[ x0 ][ y0 ] = = MODE_INTRA \| \| trafoDepth !=0 \| \| | |
| cbf_cb[ x0 ][ y0 ][ trafoDepth ] \| \| cbf_cr[ x0 ][ y0 ][ trafoDepth ] | |
| @ ) && !no_residual_syntax_flag ) | |
| cbf_luma[ x0 ][ y0 ][ trafoDepth ] | ae(v) |
| transform_unit | |
| (x0, y0, xBase, yBase, log2TrafoSize, trafoDepth, blkIdx) | |
| } | |
| } | |

In this way, the techniques may enable a video coding device, such as video encoder 20 and/or video decoder 30 shown in the examples of FIGS. 1 and 2 and FIGS. 1 and 3, respectively, to be configured to perform a method of coding a quantization parameter delta value in a coding unit (CU) of the video data before coding a version of a block of the CU in a bitstream so as to facilitate deblocking filtering.

When specifying the quantization parameter delta value, the video encoder may, as noted above, specify the quantization parameter delta value when a no_residual_syntax_flag is equal to zero (indicating that there are no blocks having cbf values equal to one). Moreover, the video encoder 20 may, again as noted above, specify the no_residual_syntax_flag in the bitstream when the block of video data is intra-coded. The video encoder may further disable the signaling of coded block flags for luma and chroma components of the block of video data when the no_residual_syntax_flag is equal to one (indicating that there is at least one block having a cbf value equal to one).

Reciprocal to much of the above video encoder operation, a video decoder, such as video decoder 30, may, when determining the quantization parameter delta value, further extract the quantization parameter delta value when a no_residual_syntax_flag is equal to zero. In some instances, video decoder 30 may also extract the no_residual_syntax_flag in the bitstream when the block of video data is intra-coded for the reasons noted above. Additionally, the video decoder 30 may determine that there are no coded block flags for luma and chroma components of the block of video data when the no_residual_syntax_flag is equal to one. As a result, the techniques may promote more efficient decoding of video data in terms of lag, while also promoting more cost efficient video coders in that less data is required to be buffered due to the delay in processing and buffer size requirements may be reduced (thereby resulting in potentially lower cost buffers).

In some instances, the techniques of this disclosure may also provide for a sub-quantization group. A sub-quantization group (sub-QG) may be defined as a block of samples within a QG, or as a block within a coding unit (CU) with dimensions larger than or equal to the QG size.

The size of the sub-QG (subQGsize×subQGsize) may typically be equal to an 8×8 block of samples, or the size may be determined by the maximum of the 8×8 block and the minimum transform unit (TU) size, although other sizes are also possible. The sub-QG may have as the upper bound for its size the quantization group size, or, if the sub-QG is located within a CU with dimensions larger than the QG size, the upper bound may be the CU size.

The (x,y) location of a sub-QG in a picture is restricted to (n*subQGsize, m*subQGsize), with n and m denoting natural numbers, and as denoted above, subQGsize denoting the size of a sub-QG. Video encoder 20 may signal the size of the sub-QG in the high-level syntax of HEVC, such as, for example, in the SPS (sequence parameter set), PPS (picture parameter set), slice header, etc. The SPS, PPS, and slice header are high-level structures that include coded syntax elements and parameters for more than one picture, a single picture, and a number of coded units of a picture, respectively.

In another example of the disclosure, a definition of the quantization parameter (QP) within a quantization group is modified such that the delta QP change only applies to the sub-QG containing the cu_qp_delta syntax element, and to the sub-QGs that come after the current sub-QG within the same QG or within the CU with dimensions larger than or equal to the QG size. Earlier sub-QGs use the predicted QP for the QG. The sub-QGs are traversed in z-scan order, in which a video coder (i.e. video encoder 20 or video decoder 30) traverses sub-QGs in the top-left corner of first, and follows a z-like pattern in traversing the rest of the sub-QGs.

This aspect of the techniques may provide one or more advantages. First, by using sub-QGs, the back propagation of the QP value, for example in the worst case described above, may be limited to the sub-QG. Moreover, in some proposals for HEVC, QP values are stored for 8×8 blocks (where the worst case may be equal to the smallest CU size). Restricting the sub-QG size to the smallest TU size of 4×4 may increase required storage by factor of four, which may be avoided if the sub-QG size is set to 8×8.

The following represents a change to HEVC WD8 reflecting the sub-QG solution (where the term “Qp region” is used below instead of the term “sub-QG”).

### “7.4.2.3 Picture Parameter Set RBSP Semantics

. . .
pic_init_qp_minus26 specifies the initial value minus 26 of SliceQP_{Y} for each slice. The initial value is modified at the slice layer when a non-zero value of slice_qp_delta is decoded, and is modified further when a non-zero value of cu_qp_delta_abs is decoded at the transform unit layer. The value of pic_init_qp_minus26 shall be in the range of −(26+QpBdOffset_{Y}) to +25, inclusive.
. . . ”

### “7.4.5.1 General Slice Header Semantics

. . .
slice_address specifies the address of the first coding tree block in the slice. The length of the slice_address syntax element is Ceil(Log 2(PicSizeInCtbsY)) bits. The value of slice_address shall be in the range of 1 to PicSizeInCtbsY−1, inclusive. When slice_address is not present, it is inferred to be equal to 0.
The variable CtbAddrRS, specifying a coding tree block address in coding tree block raster scan order, is set equal to slice_address. The variable CtbAddrTS, specifying a coding tree block address in coding tree block tile scan order, is set equal to CtbAddrRStoTS[CtbAddrRS]. The variable CuQpDelta, specifying the difference between a luma quantization parameter for the transform unit containing cu_qp_delta_abs and its prediction, is set equal to 0.
. . .
slice_qp_delta specifies the initial value of QP_{Y} to be used for the coding blocks in the slice until modified by the value of CuQpDelta in the transform unit layer. The initial QP_{Y} quantization parameter for the slice is computed as

SliceQP_{Y}=26+pic_init_qp_minus26+slice_qp_delta

The value of slice_qp_delta shall be limited such that SliceQP_{Y} is in the range of −QpBdOffset_{Y} to +51, inclusive.
. . . ”

### “7.4.11 Transform Unit Semantics

. . .
cu_qp_delta_abs specifies the absolute value of the difference between a luma quantization parameter for the transform unit containing cu_qp_delta_abs and its prediction.
cu_qp_delta_sign specifies the sign of a CuQpDelta as follows.
If cu_qp_delta_sign is equal to 0, the corresponding CuQpDelta has a positive value.
Otherwise (cu_qp_delta_sign is equal to 1), the corresponding CuQpDelta has a negative value.
   When cu_qp_delta_sign is not present, it is inferred to be equal to 0.
   When cu_qp_delta_abs is present, the variables IsCuQpDeltaCoded and CuQpDelta are derived as follows.

IsCuQpDeltaCoded=1

CuQpDelta=cu_qp_delta_abs*(1−2*cu_qp_delta_sign)

The decoded value of CuQpDelta shall be in the range of −(26+QpBdOffset_{Y}/2) to +(25+QpBdOffset_{Y}/2), inclusive.
. . . ”

### “8.4 “Decoding Process for Coding Units Coded in Intra Prediction Mode

### 8.4.1 General Decoding Process for Coding Units Coded in Intra Prediction Mode

Inputs to this process are:
a luma location (xC, yC) specifying the top-left sample of the current luma coding block relative to the top-left luma sample of the current picture,
a variable log 2CbSize specifying the size of the current luma coding block.
   Output of this process is:
a modified reconstructed picture before deblocking filtering.
   The derivation process for quantization parameters as specified in subclause 0 is invoked with the luma location (xC, yC) as input.
   . . . ”
   “ . . .

### 8.6 Scaling, Transformation and Array Construction Process Prior to Deblocking Filter Process

### 8.6.1 Derivation Process for Quantization Parameters

Input of this process is:
a luma location (xC, yC) specifying the top-left sample of the current luma coding block relative to the top left luma sample of the current picture.
   The luma location (xQG, yQG), specifies the top-left luma sample of the current quantization group relative to the top-left luma sample of the current picture. The horizontal and vertical positions xQG and yQG are set equal to (xC−(xC & ((1<<Log 2MinCuQPDeltaSize)−1))) and (yC−(yC & ((1<<Log 2MinCuQPDeltaSize)−1))), respectively.
   A Qp region within the current quantization group includes a square luma block with dimension (1<<log 2QprSize) and the two corresponding chroma blocks. log 2QprSize is set equal to Max(3, Log 2MinTrafoSize). The luma location (xQ, yQ) specifies the top-left luma sample of the Qp region relative to (xQG, yQG), with xQ and yQ equal to (iq<<log 2QprSize) and (jq<<log 2QprSize), respectively, with iq and jq=0 . . . ((1<<Log 2MinCuQPDeltaSize)>>log 2QprSize)−1. The z-scan order address zq of the Qp region (iq, jq) within the quantization group is set equal to MinTbAddrZS[iq][jq].
   The luma location (xT, yT) specifies the top-left sample of the luma transform block in the transform unit containing syntax element cu_qp_delta_abs within the current quantization group relative to the top-left luma sample of the current picture. If cu_qp_delta_abs is not decoded, then (xT, yT) is set equal to (xQG, yQG).
   The z-scan order address zqT of the Qp region covering the luma location (xT−xQG, yT−yQG) within the current quantization group is set equal to MinTbAddrZS[(xT−xQG)>>log 2QprSize][(yT−yQG)>>log 2QprSize].
   The predicted luma quantization parameter qP_{Y}_{_{—}}_{PREM} is derived by the following ordered steps:
1. The variable qP_{Y}_{_{—}}_{PREV} is derived as follows.
   If one or more of the following conditions are true, qP_{Y}_{_{—}}_{PREV} is set equal to SliceQP_{Y}.
      The current quantization group is the first quantization group in a slice.
      The current quantization group is the first quantization group in a tile.
      The current quantization group is the first quantization group in a coding tree block row and tiles_or_entry_coding_sync_idc is equal to 2.
   Otherwise, qP_{Y}_{_{—}}_{PREV} is set equal to the luma quantization parameter QP_{Y} of the last Qp region within the previous coding unit in decoding order, respectively.
2. The availability derivation process for a block in z-scan order as specified in subclause 6.4.1 is invoked with the location (xCurr, yCurr) set equal to (xB, yB) and the neighbouring location (xN, yN) set equal to (xQG−1, yQG) as the input and the output is assigned to availableA. The variable qP_{Y}_{_{—}}_{A} is derived as follows.
   If availableA is equal to FALSE or the coding tree block address of the coding tree block containing the luma coding block covering (xQG−1, yQG) ctbAddrA is not equal to CtbAddrTS, qP_{Y}_{_{—}}_{A} is set equal to qP_{Y}_{_{—}}_{PREV}.
   Otherwise, qP_{Y}_{_{—}}_{A} is set equal to the luma quantization parameter QP_{Y} of the Qp region covering (xQG−1, yQG).
3. The availability derivation process for a block in z-scan order as specified in subclause 6.4.1 is invoked with the location (xCurr, yCurr) set equal to (xB, yB) and the neighbouring location (xN, yN) set equal to (xQG, yQG−1) as the input and the output is assigned to availableB. The variable qP_{Y}_{_{—}}_{B} is derived as follows.
   If availableB is equal to FALSE or the coding tree block address of the coding tree block containing the luma coding block covering (xQG, yQG−1) ctbAddrB is not equal to ctbAddrTS, qP_{Y}_{_{—}}_{B} is set equal to qP_{Y}_{_{—}}_{PREV}.
   Otherwise, qP_{Y}_{_{—}}_{B} is set equal to the luma quantization parameter QP_{Y} of the Qp region covering (xQG, yQG−1).
4. The predicted luma quantization parameter qP_{Y}_{_{—}}_{PRED} is derived as:

qP_{Y}_{_{—}}_{PRED}=(qP_{Y}_{_{—}}_{A}+qP_{Y}_{_{—}}_{B}+1)>>1

The variable QP_{Y} of a Qp region with z-scan index zq within the current quantization group and within the current coding unit is derived as:
If index zq is greater than or equal to zqT and CuQpDelta is non-zero,

QP_{Y}=(((qP_{Y}_{_{—}}_{PRED}+CuQpDelta+52+2*QpBdOffset_{Y})%(52+QpBdOffset_{Y}))−QpBdOffset_{Y}
Otherwise:

QP_{Y}=qP_{Y}_{_{—}}_{PRED}

The luma quantization parameter QP′_{Y} is derived as

QP′_{Y}=QP_{Y}+QpBdOffset_{Y}

The variables qP_{Cb} and qP_{Cr} are set equal to the value of QP_{C} as specified in Table 8-9 based on the index qPi equal to qPi_{Cb} and qPi_{Cr} derived as:

qPi_{Cb}=Clip3(−QpBdOffset_{C},57,QP_{Y}+pic_cb_qp_offset+slice_cb_qp_offset)

qPi_{Cr}=Clip3(−QpBdOffset_{C},57,QP_{Y}+pic_cr_qp_offset+slice_cr_qp_offset)

The chroma quantization parameters for Cb and Cr components, QP′_{Cb} and QP′_{Cr} are derived as:

QP′_{Cb}=qP_{Cb}+QpBdOffset_{C}

QP′_{Cr}=qP_{Cr}+QpBdOffset_{C}

TABLE 8-9
Specification of QP_{C} as a function of qPi

| | | | | | | | | | | | | | | | | |
|---|---|---|---|---|---|---|---|---|---|---|---|---|---|---|---|---|
| qPi | <30 | 30 | 31 | 32 | 33 | 34 | 35 | 36 | 37 | 38 | 39 | 40 | 41 | 42 | 43 | >43 |
| QPc | =qPi | 29 | 30 | 31 | 32 | 33 | 33 | 34 | 34 | 35 | 35 | 36 | 36 | 37 | 37 | =qPi − 6 |
| . . . ” | | | | | | | | | | | | | | | | |

### “8.7.2.4.3 Decision Process for Luma Block Edge

. . .
The variables QP_{Q} and QP_{P} are set equal to the QP_{Y} values of the Qp regions containing the sample q_{0,0} and p_{0,0}, respectively, as specified in subclause 0 with as inputs the luma location of the coding units which include the coding blocks containing the sample q_{0,0} and p_{0,0}, respectively.
. . . ”

### “8.7.2.4.5 Filtering Process for Chroma Block Edge

The variables QP_{Q} and QP_{P} are set equal to the QP_{Y} values of the Qp regions containing the sample q_{0,0} and p_{0,0}, respectively, as specified in subclause 0 with as inputs the luma location of the coding units which include the coding blocks containing the sample q_{0,0} and p_{0,0}, respectively.
. . . ”

In some aspects, the techniques of this disclosure may provide for checking a split_transfrom_flag syntax element (hereinafter a “split transform flag”) to signal the cu_qp_delta value. The split_transform_flag syntax element specifies whether a block is split into four blocks with half horizontal and half vertical size for the purpose of transform coding. This aspect of the techniques of this disclosure uses the split transform flag in the transform_tree syntax to indicate whether a cbf flag is nonzero within an intra- or inter-coded CU. In one proposed HEVC draft, video encoder 20 may code a transform tree even if all cbf flags are zero, i.e. there are no transform coefficients in any of the TUs. Therefore, this aspect of the techniques of this disclosure institutes mandatory decoder cbf flag checking for each of the blocks of a CU to determine whether any CUs have transform coefficients. If none of the blocks of the CU have transform coefficients, this aspect of the techniques of this disclosure further prohibits video encoder 20 from coding a transform tree if all cbf flags are zero. Thus, in this case, the signaling of the cu_qp_delta, i.e. the delta QP, may be made dependent on the split_transform_flag as illustrated in the following table.

Again, lines in Table 4, below beginning with “@” symbols denote additions in syntax from those specified either in the recently adopted proposal or the HEVC standard. Lines in Table 4, below beginning with “#” symbols denote removals in syntax from those specified either in the recently adopted proposal or the HEVC standard.

TABLE 4
split_transform_flag Transform Tree Syntax

| | Descriptor |
|---|---|
| transform_tree( x0, y0, xBase, yBase, log2TrafoSize, trafoDepth, blkIdx ) { | |
| if( log2TrafoSize <= Log2MaxTrafoSize && | |
| log2TrafoSize > Log2MinTrafoSize && | |
| trafoDepth < MaxTrafoDepth && !(IntraSplitFlag && trafoDepth = = | |
| 0) ) | |
| split_transform_flag[ x0 ][ y0 ][ trafoDepth ] | ae(v) |
| if( split_transform_flag [ x0 ][ y0 ][ trafoDepth ] && trafoDepth = = 0 | |
| && | |
| @ cu_qp_delta_enabled flag && !IsCuQpDeltaCoded) { | |
| @ cu_qp_delta_abs | ae(v) |
| @ if( cu_qp_delta_abs ) | |
| @ cu_qp_delta_sign | ae(v) |
| @ } | |
| if( trafoDepth = = 0 \| \| log2TrafoSize > 2) { | |
| if( trafoDepth = = 0 \| \| cbf_cb[ xBase ][ yBase ][ trafoDepth − 1 ] ) | |
| cbf_cb[ x0 ][ y0 ][ trafoDepth ] | ae(v) |
| if( trafoDepth = = 0 \| \| cbf_cr[ xBase ][ yBase ][ trafoDepth − 1 ] ) | |
| cbf_cr[ x0 ][ y0 ][ trafoDepth ] | ae(v) |
| } | |
| if( split_transform_flag[ x0 ][ y0 ][ trafoDepth ] ) { | |
| x1 = x0 + ( ( 1 << log2TrafoSize ) >> 1 ) | |
| y1 = y0 + ( ( 1 << log2TrafoSize ) >> 1 ) | |
| transform_tree( x0, y0, x0, y0, log2TrafoSize − 1, trafoDepth + 1, 0 ) | |
| transform_tree( x1, y0, x0, y0, log2TrafoSize − 1 trafoDepth + 1, 1 ) | |
| transform_tree( x0, y1, x0, y0, log2TrafoSize − 1, trafoDepth + 1, 2 ) | |
| transform_tree( x1, y1, x0, y0, log2TrafoSize − 1, trafoDepth + 1, 3 ) | |
| } else { | |
| if( PredMode[ x0 ][ y0 ] = = MODE_INTRA \| \| trafoDepth != 0 \| \| | |
| cbf_cb[ x0 ][ y0 ][ trafoDepth ] \| \| cbf_cr[ x0 ][ y0 ][ trafoDepth ] ) | |
| cbf_luma[ x0 ][ y0 ][ trafoDepth ] | ae(v) |
| transform_unit (x0, y0, xBase, yBase, log2TrafoSize, trafoDepth, blkIdx) | |
| } | |
| } | |

Aspects of the techniques described in this disclosure may also provide for a split_transform_flag restriction. That is, various aspects of the techniques may disallow the video encoder 20 to code a split_transform_flag equal to 1 (indicating that a block is split into four blocks for the purpose of transform coding) in the transform tree syntax if all cbf flags that depend on it are zero. In other words, video encoder 20 may set the split transform flag equal to zero in the transform tree syntax when all of the coded block flags that depends from the split transform flag are equal to zero. Moreover, video encoder 20 may set a split transform flag equal to one in the transform tree syntax when at least one coded block flag that depends from the split transform flag is equal to one.

As mentioned above, video encoder 20 encodes video data. The video data may comprise one or more pictures. Each of the pictures may include a still image forming part of a video. In some instances, a picture may be referred to as a video “frame.” When video encoder 20 encodes the video data, video encoder 20 may generate a bitstream. The bitstream may include a sequence of bits that form a coded representation of the video data. The bitstream may include coded pictures and associated data. A coded picture is a coded representation of a picture.

To generate the bitstream, video encoder 20 may perform encoding operations on each picture in the video data. When video encoder 20 performs encoding operations on the pictures, video encoder 20 may generate a series of coded pictures and associated data. The associated data may include sequence parameter sets, picture parameter sets, adaptation parameter sets, and other syntax structures. A sequence parameter set (SPS) may contain parameters applicable to zero or more sequences of pictures. A picture parameter set (PPS) may contain parameters applicable to zero or more pictures. An adaptation parameter set (APS) may contain parameters applicable to zero or more pictures. In some examples in accordance with the sub-QG techniques of this disclosure, video encoder 20 may define one or more sub-QGs in the within a one or more parameter sets, such as the SPS, PPS, and slice header. and video decoder 30 may decode one or more sub-QGs from the SPS, PPS, and slice header.

To generate a coded picture, video encoder 20 may partition a picture into equally-sized video blocks. Each of the video blocks is associated with a treeblock. In some instances, a treeblock may also be referred to in the emerging HEVC standard as a largest coding unit (LCU) or a coding tree block (CTB). The treeblocks of HEVC may be broadly analogous to the macroblocks of previous standards, such as H.264/AVC. However, a treeblock is not necessarily limited to a particular size and may include one or more coding units (CUs). Video encoder 20 may use quadtree partitioning to partition the video blocks of treeblocks into video blocks associated with CUs, hence the name “treeblocks.”

In some examples, video encoder 20 may partition a picture into a plurality of slices. Each of the slices may include an integer number of CUs. In some instances, a slice comprises an integer number of treeblocks. In other instances, a boundary of a slice may be within a treeblock.

As part of performing an encoding operation on a picture, video encoder 20 may perform encoding operations on each slice of the picture. When video encoder 20 performs an encoding operation on a slice, video encoder 20 may generate encoded data associated with the slice. The encoded data associated with the slice may be referred to as a “coded slice.”

To generate a coded slice, video encoder 20 may perform encoding operations on each treeblock in a slice. When video encoder 20 performs an encoding operation on a treeblock, video encoder 20 may generate a coded treeblock. The coded treeblock may comprise data representing an encoded version of the treeblock.

To generate a coded treeblock, video encoder 20 may recursively perform quadtree partitioning on the video block of the treeblock to divide the video block into progressively smaller video blocks. Each of the smaller video blocks may be associated with a different CU. For example, video encoder 20 may partition the video block of a treeblock into four equally-sized sub-blocks, partition one or more of the sub-blocks into four equally-sized sub-sub-blocks, and so on. One or more syntax elements in the bitstream may indicate a maximum number of times video encoder 20 may partition the video block of a treeblock. A video block of a CU may be square in shape. The size of the video block of a CU (i.e., the size of the CU) may range from 8×8 pixels up to the size of a video block of a treeblock (i.e., the size of the treeblock) with a maximum of 64×64 pixels or greater.

When video encoder 20 encodes a non-partitioned CU, video encoder 20 may generate one or more prediction units (PUs) for the CU. A non-partitioned CU is a CU whose video block is not partitioned into video blocks for other CUs. Each of the PUs of the CU may be associated with a different video block within the video block of the CU. Video encoder 20 may generate a predicted video block for each PU of the CU. The predicted video block of a PU may be a block of samples. Video encoder 20 may use intra prediction or inter prediction to generate the predicted video block for a PU.

When video encoder 20 uses intra prediction to generate the predicted video block of a PU, video encoder 20 may generate the predicted video block of the PU based on samples, such as pixel values, of adjacent blocks with the same picture associated with the PU. When video encoder 20 uses inter prediction to generate the predicted video block of the PU, video encoder 20 may generate the predicted video block of the PU based on decoded pixel values in blocks of pictures other than the picture associated with the PU. If video encoder 20 uses intra prediction to generate predicted video blocks of the PUs of a CU, the CU is an intra-predicted CU.

When video encoder 20 uses inter prediction to generate a predicted video block for a PU, video encoder 20 may generate motion information for the PU. The motion information for a PU may indicate a portion of another picture that corresponds to the video block of the PU. In other words, the motion information for a PU may indicate a “reference block” for the PU. The reference block of a PU may be a block of pixel values in another picture. Video encoder 20 may generate the predicted video block for the PU based on the portions of the other pictures that are indicated by the motion information for the PU. If video encoder 20 uses inter prediction to generate predicted video blocks for the PUs of a CU, the CU is an inter-predicted CU.

After video encoder 20 generates predicted video blocks for one or more PUs of a CU, video encoder 20 may generate residual data for the CU based on the predicted video blocks for the PUs of the CU. The residual data for the CU may indicate differences between pixel values in the predicted video blocks for the PUs of the CU and the original video block of the CU.

Furthermore, as part of performing an encoding operation on a non-partitioned CU, video encoder 20 may perform recursive quadtree partitioning on the residual data of the CU to partition the residual data of the CU into one or more blocks of residual data (i.e., residual video blocks) associated with transform units (TUs) of the CU. Each TU of a CU may be associated with a different residual video block. Video coder 20 may perform transform operations on each TU of the CU.

The recursive partition of the CU into blocks of residual data may be referred to as a “transform tree.” The transform tree may include any TUs comprising blocks of chroma (color) and luma (luminance) residual components of a portion of the CU. The transform tree may also include coded block flags for each of the chroma and luma components, which indicate whether there are residual transform components in the TUs comprising blocks of luma and chroma samples of the transform tree. Video encoder 20 may signal the no_residual_syntax_flag in the transform tree to indicate that a delta QP is signaled at the beginning of the CU. Further, video encoder 20 may not signal a delta QP value in CU if the no_residual_syntax_flag value is equal to one.

When video encoder 20 performs the transform operation on a TU, video encoder 20 may apply one or more transforms to a residual video block, i.e., of residual pixel values, associated with the TU to generate one or more transform coefficient blocks (i.e., blocks of transform coefficients) associated with the TU. Conceptually, a transform coefficient block may be a two-dimensional (2D) matrix of transform coefficients.

In examples in accordance with the no_residual_syntax_flag aspect of this disclosure, video encoder 20 may determine whether there are any non-zero transform coefficients in the blocks of the TU(s) of a CU (e.g., as indicated by a cbf). If there are no TUs having a cbf equal to one, video encoder 20 may signal a no_residual_syntax_flag syntax element as part of the CU, indicating to decoder 20 that there are no TUs that have non-zero residual coefficients.

After generating a transform coefficient block, video encoder 20 may perform a quantization operation on the transform coefficient block. Quantization generally refers to a process in which levels of transform coefficients are quantized to possibly reduce the amount of data used to represent the transform coefficients, providing further compression. The quantization process may reduce the bit depth associated with some or all of the transform coefficients. For example, an n-bit transform coefficient may be rounded down to an m-bit transform coefficient during quantization, where n is greater than m.

Video encoder 20 may associate each CU with a quantization parameter (QP) value. The QP value associated with a CU may determine how video encoder 20 quantizes transform coefficient blocks associated with the CU. Video encoder 20 may adjust the degree of quantization applied to the transform coefficient blocks associated with a CU by adjusting the QP value associated with the CU.

Rather than signaling a quantization parameter for each CU, video encoder 20 may be configured to signal a delta QP value syntax element in a CU. The delta QP value represents the difference between a previous QP value and the QP value of the currently coded CU. Additionally, video encoder 20 may also group CUs or TUs into quantization groups (QGs) of one or more blocks. The QGs may share the same delta QP value, which video encoder 20 may derive for one of the blocks, and propagate to each of the rest of the blocks of the CU.

In accordance with the sub-QG aspect of this disclosure, video encoder 20 may also define one or more sub-QGs in the PPS, SPS, or another parameter set. The sub-QG may define blocks of the CU or of that have the same delta QP value, which may limit the delay in determining the delta QP for the blocks within the sub-QG, and increase the speed of deblocking in some cases because the number of blocks within a sub-QG may be smaller than the number of blocks in a QG, thereby reducing the maximum potential quantization parameter delta propagation delay.

After video encoder 20 quantizes a transform coefficient block, video encoder 20 may scan the quantized transform coefficients to produce a one-dimensional vector of transform coefficient levels. Video encoder 20 may entropy encode the one-dimensional vector. Video encoder 20 may also entropy encode other syntax elements associated with the video data, such as motion vectors, ref_idx, pred_dir, and other syntax elements.

The bitstream generated by video encoder 20 may include a series of Network Abstraction Layer (NAL) units. Each of the NAL units may be a syntax structure containing an indication of a type of data in the NAL unit and bytes containing the data. For example, a NAL unit may contain data representing a sequence parameter set, a picture parameter set, a coded slice, supplemental enhancement information (SEI), an access unit delimiter, filler data, or another type of data. The data in a NAL unit may include entropy encoded syntax structures, such as entropy-encoded transform coefficient blocks, motion information, and so on. The data of a NAL unit may be in the form of a raw byte sequence payload (RBSP) interspersed with emulation prevention bits. A RBSP may be a syntax structure containing an integer number of bytes that is encapsuled within a NAL unit.

A NAL unit may include a NAL header that specifies a NAL unit type code. For instance, a NAL header may include a “nal_unit_type” syntax element that specifies a NAL unit type code. The NAL unit type code specified by the NAL header of a NAL unit may indicate the type of the NAL unit. Different types of NAL units may be associated with different types of RBSPs. In some instances, multiple types of NAL units may be associated with the same type of RBSP. For example, if a NAL unit is a sequence parameter set NAL unit, the RBSP of the NAL unit may be a sequence parameter set RBSP. However, in this example, multiple types of NAL units may be associated with the slice layer RBSP. NAL units that contain coded slices may be referred to herein as coded slice NAL units.

Video decoder 30 may receive the bitstream generated by video encoder 20. The bitstream may include a coded representation of the video data encoded by video encoder 20. When video decoder 30 receives the bitstream, video decoder 30 may perform a parsing operation on the bitstream. When video decoder 30 performs the parsing operation, video decoder 30 may extract syntax elements from the bitstream. Video decoder 30 may reconstruct the pictures of the video data based on the syntax elements extracted from the bitstream. The process to reconstruct the video data based on the syntax elements may be generally reciprocal to the process performed by video encoder 20 to generate the syntax elements.

After video decoder 30 extracts the syntax elements associated with a CU, video decoder 30 may generate predicted video blocks for the PUs of the CU based on the syntax elements. In addition, video decoder 30 may inverse quantize transform coefficient blocks associated with TUs of the CU. Video decoder 30 may perform inverse transforms on the transform coefficient blocks to reconstruct residual video blocks associated with the TUs of the CU. After generating the predicted video blocks and reconstructing the residual video blocks, video decoder 30 may reconstruct the video block of the CU based on the predicted video blocks and the residual video blocks. In this way, video decoder 30 may determine the video blocks of CUs based on the syntax elements in the bitstream.

As described in greater detail below, video encoder 20 and video decoder 30 may perform the techniques described in this disclosure.

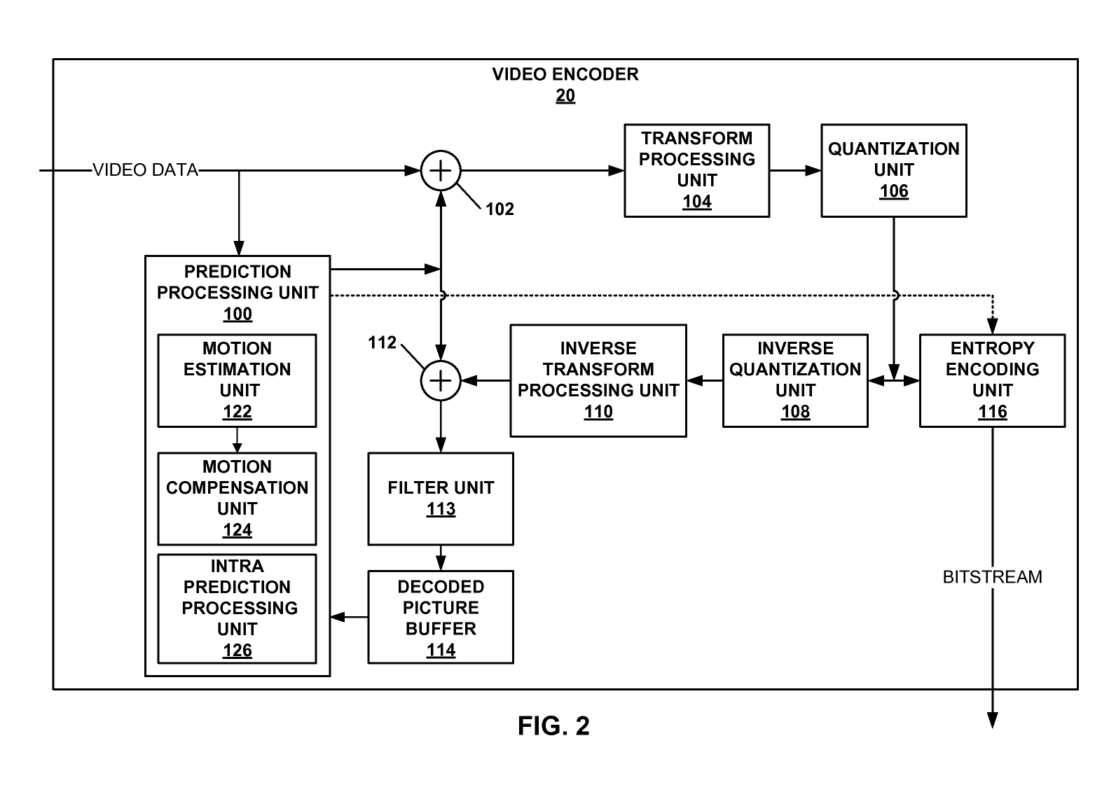

FIG. 2 is a block diagram that illustrates an example video encoder 20 may be configured to implement the techniques of this disclosure for reducing the delay in determining the delta QP of blocks of CUs, which may inhibit deblocking FIG. 2 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 2, video encoder 20 includes a plurality of functional components. The functional components of video encoder 20 include a prediction processing unit 100, a residual generation unit 102, a transform processing unit 104, a quantization unit 106, an inverse quantization unit 108, an inverse transform processing unit 110, a reconstruction unit 112, a filter unit 113, a decoded picture buffer 114, and an entropy encoding unit 116. Prediction processing unit 100 includes a motion estimation unit 122, a motion compensation unit 124, and an intra prediction processing unit 126. In other examples, video encoder 20 may include more, fewer, or different functional components. Furthermore, motion estimation unit 122 and motion compensation unit 124 may be highly integrated, but are represented in the example of FIG. 2 separately for purposes of explanation.

Video encoder 20 may receive video data. Video encoder 20 may receive the video data from various sources. For example, video encoder 20 may receive the video data from video source 18 (FIG. 1) or another source. The video data may represent a series of pictures. To encode the video data, video encoder 20 may perform an encoding operation on each of the pictures. As part of performing the encoding operation on a picture, video encoder 20 may perform encoding operations on each slice of the picture. As part of performing an encoding operation on a slice, video encoder 20 may perform encoding operations on treeblocks in the slice.

Video encoder 20 may perform encoding operations on each non-partitioned CU of a treeblock. When video encoder 20 performs an encoding operation on a non-partitioned CU, video encoder 20 generates data representing an encoded representation of the non-partitioned CU.

As part of performing an encoding operation on a treeblock, prediction processing unit 100 may perform quadtree partitioning on the video block of the treeblock to divide the video block into progressively smaller video blocks. Each of the smaller video blocks may be associated with a different CU. For example, prediction processing unit 100 may partition a video block of a treeblock into four equally-sized sub-blocks, partition one or more of the sub-blocks into four equally-sized sub-sub-blocks, and so on.

The sizes of the video blocks associated with CUs may range from 8×8 samples up to the size of the treeblock with a maximum of 64×64 samples or greater. In this disclosure, “N×N” and “N by N” may be used interchangeably to refer to the sample dimensions of a video block in terms of vertical and horizontal dimensions, e.g., 16×16 samples or 16 by 16 samples. In general, a 16×16 video block has sixteen samples in a vertical direction (y=16) and sixteen samples in a horizontal direction (x=16). Likewise, an N×N block generally has N samples in a vertical direction and N samples in a horizontal direction, where N represents a nonnegative integer value.

Furthermore, as part of performing the encoding operation on a treeblock, prediction processing unit 100 may generate a hierarchical quadtree data structure for the treeblock. For example, a treeblock may correspond to a root node of the quadtree data structure. If prediction processing unit 100 partitions the video block of the treeblock into four sub-blocks, the root node has four child nodes in the quadtree data structure. Each of the child nodes corresponds to a CU associated with one of the sub-blocks. If prediction processing unit 100 partitions one of the sub-blocks into four sub-sub-blocks, the node corresponding to the CU associated with the sub-block may have four child nodes, each of which corresponds to a CU associated with one of the sub-sub-blocks.

Each node of the quadtree data structure may contain syntax data (e.g., syntax elements) for the corresponding treeblock or CU. For example, a node in the quadtree may include a split flag that indicates whether the video block of the CU corresponding to the node is partitioned (i.e., split) into four sub-blocks. Syntax elements for a CU may be defined recursively, and may depend on whether the video block of the CU is split into sub-blocks. A CU whose video block is not partitioned may correspond to a leaf node in the quadtree data structure. A CTB may include data based on the quadtree data structure for a corresponding treeblock.

As part of performing an encoding operation on a CU, prediction processing unit 100 may partition the video block of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N, and inter-prediction in symmetric PU sizes of 2N×2N, 2N×N, N×2N, N×N, 2N×nU, nL×2N, nR×2N, or similar. Video encoder 20 and video decoder 30 may also support asymmetric partitioning for PU sizes of 2N×nU, 2N×nD, nL×2N, and nR×2N. In some examples, prediction processing unit 100 may perform geometric partitioning to partition the video block of a CU among PUs of the CU along a boundary that does not meet the sides of the video block of the CU at right angles.

Motion estimation unit 122 and motion compensation unit 124 may perform inter prediction on each PU of the CU. Inter prediction may provide temporal compression. To perform inter prediction on a PU, motion estimation unit 122 may generate motion information for the PU. Motion compensation unit 124 may generate a predicted video block for the PU based the motion information and decoded samples of pictures other than the picture associated with the CU (i.e., reference pictures). In this disclosure, a predicted video block generated by motion compensation unit 124 may be referred to as an inter-predicted video block.

Slices may be I slices, P slices, or B slices. Motion estimation unit 122 and motion compensation unit 124 may perform different operations for a PU of a CU depending on whether the PU is in an I slice, a P slice, or a B slice. In an I slice, all PUs are intra predicted. Hence, if the PU is in an I slice, motion estimation unit 122 and motion compensation unit 124 do not perform inter prediction on the PU.

If the PU is in a P slice, the picture containing the PU is associated with a list of reference pictures referred to as “list 0.” Each of the reference pictures in list 0 contains samples that may be used for inter prediction of subsequent pictures in decoding order. When motion estimation unit 122 performs the motion estimation operation with regard to a PU in a P slice, motion estimation unit 122 may search the reference pictures in list 0 for a reference block for the PU. The reference block of the PU may be a set of samples, e.g., a block of samples that most closely corresponds to the samples in the video block of the PU. Motion estimation unit 122 may use a variety of metrics to determine how closely a set of samples in a reference picture corresponds to the samples in the video block to be coded in a PU. For example, motion estimation unit 122 may determine how closely a set of samples in a reference picture corresponds to the samples in the video block of a PU by sum of absolute difference (SAD), sum of square difference (SSD), or other difference metrics.

After identifying a reference block of a PU in a P slice, motion estimation unit 122 may generate a reference index that indicates the reference picture in list 0 containing the reference block and a motion vector that indicates a spatial displacement between the PU and the reference block. In various examples, motion estimation unit 122 may generate motion vectors to varying degrees of precision. For example, motion estimation unit 122 may generate motion vectors at one-quarter sample precision, one-eighth sample precision, or other fractional sample precision. In the case of fractional sample precision, reference block values may be interpolated from integer-position sample values in the reference picture. Motion estimation unit 122 may output the reference index and the motion vector as the motion information of the PU. Motion compensation unit 124 may generate a predicted video block of the PU based on the reference block identified by the motion information of the PU.

If the PU is in a B slice, the picture containing the PU may be associated with two lists of reference pictures, referred to as “list 0” and “list 1.” Each of the reference pictures in list 0 contains samples that may be used for inter prediction of subsequent pictures in decoding order. The reference pictures in list 1 occur before the picture in decoding order but after the picture in presentation order. In some examples, a picture containing a B slice may be associated with a list combination that is a combination of list 0 and list 1.

Furthermore, if the PU is in a B slice, motion estimation unit 122 may perform uni-directional prediction or bi-directional prediction for the PU. When motion estimation unit 122 performs uni-directional prediction for the PU, motion estimation unit 122 may search the reference pictures of list 0 or list 1 for a reference block for the PU. Motion estimation unit 122 may then generate a reference index that indicates the reference picture in list 0 or list 1 that contains the reference block and a motion vector that indicates a spatial displacement between the PU and the reference block. Motion estimation unit 122 may output the reference index, a prediction direction indicator, and the motion vector as the motion information of the PU. The prediction direction indicator may indicate whether the reference index indicates a reference picture in list 0 or list 1. Motion compensation unit 124 may generate the predicted video block of the PU based on the reference block indicated by the motion information of the PU.

When motion estimation unit 122 performs bi-directional prediction for a PU, motion estimation unit 122 may search the reference pictures in list 0 for a reference block for the PU and may also search the reference pictures in list 1 for another reference block for the PU. Motion estimation unit 122 may then generate reference indexes that indicate the reference pictures in list 0 and list 1 containing the reference blocks and motion vectors that indicate spatial displacements between the reference blocks and the PU. Motion estimation unit 122 may output the reference indexes and the motion vectors of the PU as the motion information of the PU. Motion compensation unit 124 may generate the predicted video block of the PU based on the reference blocks indicated by the motion information of the PU.

In some instances, motion estimation unit 122 does not output a full set of motion information for a PU to entropy encoding unit 116. Rather, motion estimation unit 122 may signal the motion information of a PU with reference to the motion information of another PU. For example, motion estimation unit 122 may determine that the motion information of the PU is sufficiently similar to the motion information of a neighboring PU. In this example, motion estimation unit 122 may indicate, in a quadtree node for a CU associated with the PU, a value that indicates to video decoder 30 that the PU has the same motion information as the neighboring PU. In another example, motion estimation unit 122 may identify, in a quadtree node associated with the CU associated with the PU, a neighboring PU and a motion vector difference (MVD). The motion vector difference indicates a difference between the motion vector of the PU and the motion vector of the indicated neighboring PU. Video decoder 30 may use the motion vector of the indicated neighboring PU and the motion vector difference to predict the motion vector of the PU. By referring to the motion information of a first PU when signaling the motion information of a second PU, video encoder 20 may be able to signal the motion information of the second PU using fewer bits.

As part of performing an encoding operation on a CU, intra prediction processing unit 126 may perform intra prediction on PUs of the CU. Intra prediction may provide spatial compression. When intra prediction processing unit 126 performs intra prediction on a PU, intra prediction processing unit 126 may generate prediction data for the PU based on decoded samples of other PUs in the same picture. The prediction data for the PU may include a predicted video block and various syntax elements. Intra prediction processing unit 126 may perform intra prediction on PUs in I slices, P slices, and B slices.

To perform intra prediction on a PU, intra prediction processing unit 126 may use multiple intra prediction modes to generate multiple sets of prediction data for the PU. When intra prediction processing unit 126 uses an intra prediction mode to generate a set of prediction data for the PU, intra prediction processing unit 126 may extend samples from video blocks of neighboring PUs across the video block of the PU in a direction and/or gradient associated with the intra prediction mode. The neighboring PUs may be above, above and to the right, above and to the left, or to the left of the PU, assuming a left-to-right, top-to-bottom encoding order for PUs, CUs, and treeblocks. Intra prediction processing unit 126 may use various numbers of intra prediction modes, e.g., 33 directional intra prediction modes, depending on the size of the PU.

Prediction processing unit 100 may select the prediction data for a PU from among the prediction data generated by motion compensation unit 124 for the PU or the prediction data generated by intra prediction processing unit 126 for the PU. In some examples, prediction processing unit 100 selects the prediction data for the PU based on rate/distortion metrics of the sets of prediction data.

If prediction processing unit 100 selects prediction data generated by intra prediction processing unit 126, prediction processing unit 100 may signal the intra prediction mode that was used to generate the prediction data for the PUs, i.e., the selected intra prediction mode. Prediction processing unit 100 may signal the selected intra prediction mode in various ways. For example, it is probable the selected intra prediction mode is the same as the intra prediction mode of a neighboring PU. In other words, the intra prediction mode of the neighboring PU may be the most probable mode for the current PU. Thus, prediction processing unit 100 may generate a syntax element to indicate that the selected intra prediction mode is the same as the intra prediction mode of the neighboring PU.

After prediction processing unit 100 selects the prediction data for PUs of a CU, residual generation unit 102 may generate residual data for the CU by subtracting the predicted video blocks of the PUs of the CU from the video block of the CU. The residual data of a CU may include 2D residual video blocks that correspond to different sample components of the samples in the video block of the CU. For example, the residual data may include a residual video block that corresponds to differences between luminance components of samples in the predicted video blocks of the PUs of the CU and luminance components of samples in the original video block of the CU. In addition, the residual data of the CU may include residual video blocks that correspond to the differences between chrominance components of samples in the predicted video blocks of the PUs of the CU and the chrominance components of the samples in the original video block of the CU.

Prediction processing unit 100 may perform quadtree partitioning to partition the residual video blocks of a CU into sub-blocks. Each undivided residual video block may be associated with a different TU of the CU. The sizes and positions of the residual video blocks associated with TUs of a CU may or may not be based on the sizes and positions of video blocks associated with the PUs of the CU. A quadtree structure known as a “residual quad tree” (RQT) may include nodes associated with each of the residual video blocks. Non-partitioned TUs of a CU may correspond to leaf nodes of the RQT.

A TU may have one or more sub-TUs if the residual video block associated with the TU is partitioned into multiple smaller residual video blocks. Each of the smaller residual video blocks may be associated with a different one of the sub-TUs.

Transform processing unit 104 may generate one or more transform coefficient blocks for each non-partitioned TU of a CU by applying one or more transforms to a residual video block associated with the TU. Each of the transform coefficient blocks may be a 2D matrix of transform coefficients. Transform processing unit 104 may apply various transforms to the residual video block associated with a TU. For example, transform processing unit 104 may apply a discrete cosine transform (DCT), a directional transform, or a conceptually similar transform to the residual video block associated with a TU.

After transform processing unit 104 generates a transform coefficient block associated with a TU, quantization unit 106 may quantize the transform coefficients in the transform coefficient block. Quantization unit 106 may quantize a transform coefficient block associated with a TU of a CU based on a QP value associated with the CU.

Video encoder 20 may associate a QP value with a CU in various ways. For example, video encoder 20 may perform a rate-distortion analysis on a treeblock associated with the CU. In the rate-distortion analysis, video encoder 20 may generate multiple coded representations of the treeblock by performing an encoding operation multiple times on the treeblock. Video encoder 20 may associate different QP values with the CU when video encoder 20 generates different encoded representations of the treeblock. Video encoder 20 may signal that a given QP value is associated with the CU when the given QP value is associated with the CU in a coded representation of the treeblock that has a lowest bitrate and distortion metric. Often when signaling this given QP, video encoder 20 may signal a delta QP value in the manner described above.

More specifically, quantization unit 106 may identify a quantization parameter for a block of video data and compute the quantization parameter delta value as a difference between the identified quantization parameter for the block of video data and a quantization parameter determined or identified for a reference block of video data. Quantization unit 106 may then provide this quantization parameter delta value to entropy coding unit 116, which may signal this quantization parameter delta value in the bitstream.

In accordance with examples of split transform flag aspects of this disclosure, once quantization unit 106 has determined the quantization parameter delta value for a CU, and transform processing unit 104 has determined whether there are any residual coefficients for blocks of the CU, prediction processing unit 100 may generate syntax elements including a split transform flag, as well as other syntax elements of the CU based on the split transform flag CU.

In one example in accordance with this aspect, prediction processing unit 100 may determine whether to encode the transform block of the CU based on the split transform flag. More particularly, prediction processing unit 100 may determine whether one or more coded block flags are zero within a block of video data based on the split transform flag, i.e. if any blocks have transform coefficients, and encode a transform tree for the block based on the determination. Prediction processing unit 100 may code the transform tree in response to the determining that one or more coded block flags are not zero within the block of video data based on the split transform flag.

Video encoder 20 may specify the quantization parameter delta value when a no_residual_syntax_flag is equal to zero. In some instances, video encoder 20 may further specify the no_residual_syntax_flag in the bitstream when the block of video data is intra-coded. Video encoder 20 may additionally disable the signaling of coded block flags for luma and chroma components of the block of video data when the no_residual_syntax_flag is equal to one.

Prediction processing unit 100 may also signal the quantization parameter delta value in the CU based on the split transform flag. As examples, if the split transform flag is equal to one, prediction processing unit 100 may signal the quantization parameter delta value in the CU. If the split transform flag is equal to zero, prediction processing unit 100 may not signal the quantization parameter delta value.

In other examples in accordance with the split transform flag aspect, prediction processing unit 100 may be configured to encode the split transform flag based on the coded block flag values of a CU. In a first example, prediction processing unit 100 may be configured to set a split transform flag equal to one in the transform tree syntax when at least one coded block flag that depends from the split transform is equal to one. In another example, prediction processing unit 100 may be configured to set a split transform flag equal to zero in the transform tree syntax when all of the coded block flags that depend from the split transform flag are equal to zero.

Prediction processing unit 100 may encode the quantization parameter delta based value in the transform tree based on whether the split transform flag of the CU is equal to one. If the split transform flag is equal to one, prediction processing unit 100 or quantization unit 106 may encode the quantization parameter delta value in the transform tree. If the split transform flag is equal to zero, prediction processing unit 100 or quantization unit 106 may not encode the quantization parameter delta value in the transform tree.

Prediction processing unit 100 may also determine whether to encode a next level of the transform tree based whether any blocks of the transform tree have a cbf equal to one, i.e. have transform coefficients. If no blocks of the tree have a cbf equal to one, prediction processing unit 100 may not encode a next level of the transform tree.

Conversely, if at least one block has a cbf equal to one, prediction processing unit 100 may be configured to encode a next level of the transform tree. Thus, prediction processing unit 100 may be configured to determine whether one or more coded block flags, which indicate whether there are any residual transform coefficients in a block of video data, are equal to zero within blocks of a transform tree based on a split transform flag, and encode a transform tree for the blocks of video data based on the determination.

In other examples in accordance with the techniques of this aspect of the disclosure, prediction processing unit 100 may determine whether any coded block flags of any blocks of a CU are equal to one. If no blocks have a cbf equal to one, prediction processing unit 100 may not be allowed to encode the split transform flag having a value equal to one. Thus, prediction processing unit 100 may be configured to set a split transform flag equal to one in the transform tree syntax when at least one coded block flag that depends from the split transform flag is equal to one.

Prediction processing unit 100 may also be configured to signal the split transform flag based on the cbf values of blocks of a CU. More particularly, if prediction processing unit 100 determines that the split transform flag is equal to zero, prediction processing unit 100 may be configured to set a split transform flag equal to zero in the transform tree syntax when all of the coded block flags that depends from the split transform flag are equal to zero. Prediction processing unit 100 may also be configured to set a split transform flag equal to one in the transform tree syntax when at least one coded block flag that depends from the split transform flag is equal to one.

Inverse quantization unit 108 and inverse transform processing unit 110 may apply inverse quantization and inverse transforms to the transform coefficient block, respectively, to reconstruct a residual video block from the transform coefficient block. Reconstruction unit 112 may add the reconstructed residual video block to corresponding samples from one or more predicted video blocks generated by prediction processing unit 100 to produce a reconstructed video block associated with a TU. By reconstructing video blocks for each TU of a CU in this way, video encoder 20 may reconstruct the video block of the CU.

After reconstruction unit 112 reconstructs the video block of a CU, filter unit 113 may perform a deblocking operation to reduce blocking artifacts in the video block associated with the CU. In addition, filter unit 113 may apply sample filtering operations. After performing these operations, filter unit 113 may store the reconstructed video block of the CU in decoded picture buffer 114. Motion estimation unit 122 and motion compensation unit 124 may use a reference picture that contains the reconstructed video block to perform inter prediction on PUs of subsequent pictures. In addition, intra prediction processing unit 126 may use reconstructed video blocks in decoded picture buffer 114 to perform intra prediction on other PUs in the same picture as the CU.

In examples in accordance with this aspect, prediction unit may receive from quantization unit 106, a quantization parameter delta value (i.e. a delta QP value) for a CU. Prediction processing unit 100 may encode the quantization parameter delta value as a syntax element in the CU in order to reduce delay in deblocking, and the CU may come earlier in an encoded video bitstream than block data of the CU. Thus, prediction processing unit 100 may be configured code a quantization parameter delta value in a coding unit (CU) of the video data before coding a version of a block of the CU in a bitstream so as to facilitate deblocking filtering.

Prediction processing unit 100 may be further configured to encode the quantization parameter delta value based on the value of a no_residual_syntax_flag syntax element. if the no_residual_syntax_flag is equal to zero. Thus, in some examples in accordance with this aspect, prediction processing unit 100 may be configured to encode the quantization parameter delta value when the no_residual_syntax_flag value of the block is equal to zero.

If the no_residual_syntax_flag value is equal to one, prediction processing unit 100 configured in accordance with this aspect, may be prohibited from encoding coded block flags for luma and chroma components of a block. Thus, prediction processing unit 100 may be configured to disable the encoding of coded block flags for luma and chroma components of the block of video data when the no_residual_syntax_flag is equal to one. In some examples, prediction processing unit 100 may encode the no_residual_syntax_flag value when the block of video data is intra-coded.

In examples of the sub-QG aspect of this disclosure, prediction processing unit 100 may receive quantization parameters of blocks of a CU from quantization unit 106. Prediction unit 106 unit may initially group blocks into quantization groups (QGs), which have a same quantization parameter delta value. In a further effort to avoid inhibiting deblocking, prediction unit 110 may group blocks into sub-QGs, which may be a block of samples within a QG or a block within a video block with dimensions larger than or equal to a size of the quantization group. Thus, in accordance with this aspect, prediction processing unit 100 may be configured to determine a sub-quantization group. The sub-quantization group comprises: 1) a block of samples within a quantization group or 2) a block within a video block with dimensions larger than or equal to a size of the quantization group. Quantization unit 106 may be further configured to perform quantization with respect to the determined sub-quantization group.

In some instances, prediction processing unit 100 may determine the size of a sub-QG to be equal to an 8×8 block of samples and code syntax elements indicating the size of the sub-QG. Prediction processing unit 100 may also determine the size of the sub-QG as a maximum of an 8×8 block and a minimum transform unit size applied to the video block. In some instances, a sub-QG may also have an upper size bound. The upper bound may be equal to either the size of the quantization group or, when the sub-QG is located within a block of video data with dimensions larger than the size of the quantization group, a size of the block of video data.

Prediction processing unit 100 further determines a location of a sub-QG, and signals a location of the sub-QG within a picture in which the blocks of the sub-QG are located. In various examples, prediction processing unit 100 may restrict the location of a sub-QG may be restricted to an x-coordinate computed as a result of multiplying a variable n times the size of the sub-quantization group and a y-coordinate computed as a result of multiplying a variable m times the size of the sub-quantization group (n*subQGsize, m*subQGsize).

Inverse quantization unit 108 may further utilize the delta quantization parameter value from quantization parameter unit 106 to reconstruct a quantization parameter. Quantization unit 106 may further provide the quantization parameter determined for one sub-QG to inverse quantization unit 108 for a subsequent sub-QG. Inverse quantization unit 108 may perform inverse quantization on the subsequent sub-QG.

Entropy encoding unit 116 may receive data from other functional components of video encoder 20. For example, entropy encoding unit 116 may receive transform coefficient blocks from quantization unit 106 and may receive syntax elements from prediction processing unit 100. Entropy coding unit 116 may also receive the quantization parameter delta value from quantization unit 106, as noted above, and perform the techniques described in this disclosure to signal this quantization parameter delta value in such a manner that enables video decoder 30 to extract this quantization parameter delta value, compute the quantization parameter based on this quantization parameter delta value and apply inverse quantization using this quantization parameter such that deblocking filter may be more timely applied to the reconstructed video block.

In any event, when entropy encoding unit 116 receives the data, entropy encoding unit 116 may perform one or more entropy encoding operations to generate entropy encoded data. For example, video encoder 20 may perform a context adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, or another type of entropy encoding operation on the data. Entropy encoding unit 116 may output a bitstream that includes the entropy encoded data.

As part of performing an entropy encoding operation on data, entropy encoding unit 116 may select a context model. If entropy encoding unit 116 is performing a CABAC operation, the context model may indicate estimates of probabilities of particular bins having particular values. In the context of CABAC, the term “bin” is used to refer to a bit of a binarized version of a syntax element.

In examples in accordance with the no_residual_syntax_flag aspect of this disclosure, entropy encoding unit 116 may be configured to entropy encode the no_residual_syntax_flag using CABAC.

If the entropy encoding unit 116 is performing a CAVLC operation, the context model may map coefficients to corresponding codewords. Codewords in CAVLC may be constructed such that relatively short codes correspond to more probable symbols, while relatively long codes correspond to less probable symbols. Selection of an appropriate context model may impact coding efficiency of the entropy encoding operation.

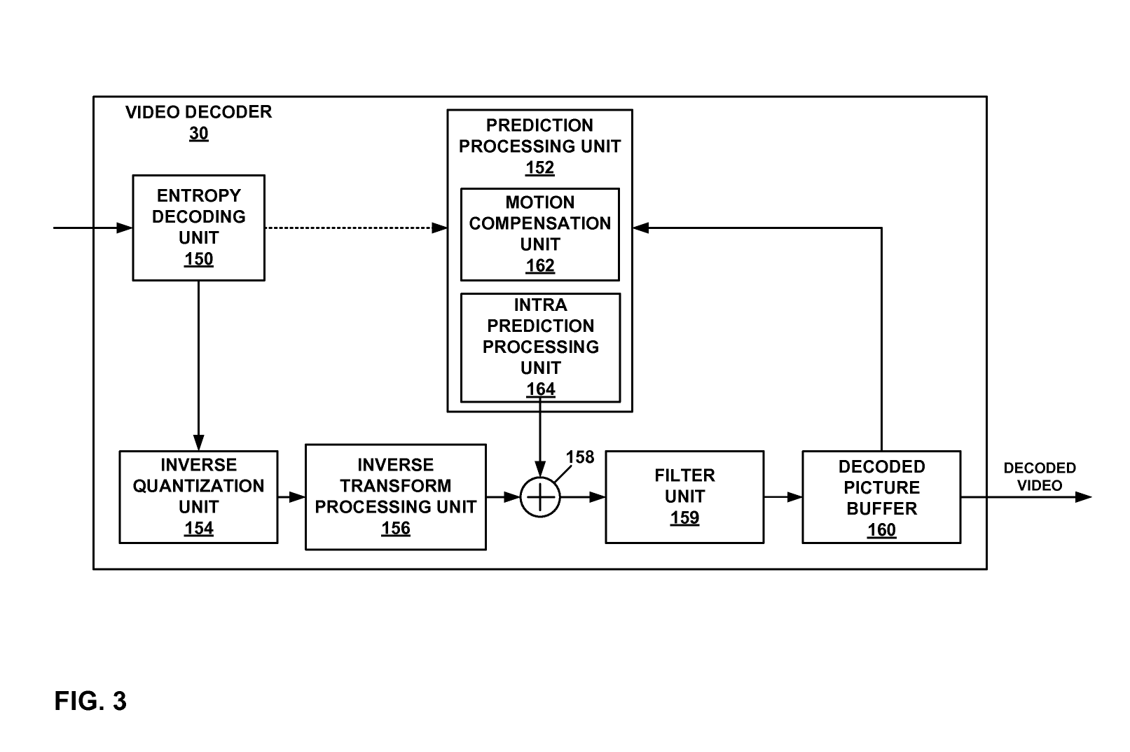

FIG. 3 is a block diagram that illustrates an example video decoder 30 that may be configured to implement the techniques of this disclosure for reducing the delay in determining the delta QP of blocks of CUs, which may inhibit deblocking. For purposes of explanation, this disclosure describes video decoder 30 in the context of HEVC coding. However, the techniques of this disclosure may be applicable to other coding standards or methods.

In the example of FIG. 3, video decoder 30 includes a plurality of functional components. The functional components of video decoder 30 include an entropy decoding unit 150, a prediction processing unit 152, an inverse quantization unit 154, an inverse transform processing unit 156, a reconstruction unit 158, a filter unit 159, and a decoded picture buffer 160. Prediction processing unit 152 includes a motion compensation unit 162 and an intra prediction processing unit 164. In some examples, video decoder 30 may perform a decoding pass generally reciprocal to the encoding pass described with respect to video encoder 20 of FIG. 2. In other examples, video decoder 30 may include more, fewer, or different functional components.

Video decoder 30 may receive a bitstream that comprises encoded video data. The bitstream may include a plurality of syntax elements. When video decoder 30 receives the bitstream, entropy decoding unit 150 may perform a parsing operation on the bitstream. As a result of performing the parsing operation on the bitstream, entropy decoding unit 150 may extract syntax elements from the bitstream. As part of performing the parsing operation, entropy decoding unit 150 may entropy decode entropy encoded syntax elements in the bitstream. Entropy decoding unit 150 may implement the techniques described in this disclosure to potentially more readily identify a quantization parameter delta value so that deblocking filtering by filter unit 159 may be more timely performed in a manner that reduces lag and potentially results in smaller buffer size requirements. Prediction processing unit 152, inverse quantization unit 154, inverse transform processing unit 156, reconstruction unit 158, and filter unit 159 may perform a reconstruction operation that generates decoded video data based on the syntax elements extracted from the bitstream.

As discussed above, the bitstream may comprise a series of NAL units. The NAL units of the bitstream may include sequence parameter set NAL units, picture parameter set NAL units, SEI NAL units, and so on. As part of performing the parsing operation on the bitstream, entropy decoding unit 150 may perform parsing operations that extract and entropy decode sequence parameter sets from sequence parameter set NAL units, picture parameter sets from picture parameter set NAL units, SEI data from SEI NAL units, and so on.

In addition, the NAL units of the bitstream may include coded slice NAL units. As part of performing the parsing operation on the bitstream, entropy decoding unit 150 may perform parsing operations that extract and entropy decode coded slices from the coded slice NAL units. Each of the coded slices may include a slice header and slice data. The slice header may contain syntax elements pertaining to a slice. The syntax elements in the slice header may include a syntax element that identifies a picture parameter set associated with a picture that contains the slice. Entropy decoding unit 150 may perform an entropy decoding operation, such as a CAVLC decoding operation, on the coded slice header to recover the slice header.

After extracting the slice data from coded slice NAL units, entropy decoding unit 150 may extract coded treeblocks from the slice data. Entropy decoding unit 150 may then extract coded CUs from the coded treeblocks. Entropy decoding unit 150 may perform parsing operations that extract syntax elements from the coded CUs. The extracted syntax elements may include entropy-encoded transform coefficient blocks. Entropy decoding unit 150 may then perform entropy decoding operations on the syntax elements. For instance, entropy decoding unit 150 may perform CABAC operations on the transform coefficient blocks.

After entropy decoding unit 150 performs a parsing operation on a non-partitioned CU, video decoder 30 may perform a reconstruction operation on the non-partitioned CU. A non-partitioned CU may include a transform tree structure comprising one or more prediction units and one or more TUs. To perform the reconstruction operation on a non-partitioned CU, video decoder 30 may perform a reconstruction operation on each TU of the CU. By performing the reconstruction operation for each TU of the CU, video decoder 30 may reconstruct a residual video block associated with the CU.

As part of performing a reconstruction operation on a TU, inverse quantization unit 154 may inverse quantize, i.e., de-quantize, a transform coefficient block associated with the TU. Inverse quantization unit 154 may inverse quantize the transform coefficient block in a manner similar to the inverse quantization processes proposed for HEVC or defined by the H.264 decoding standard. Inverse quantization unit 154 may use a quantization parameter QP calculated by video encoder 20 for a CU of the transform coefficient block to determine a degree of quantization and, likewise, a degree of inverse quantization for inverse quantization unit 154 to apply.

Inverse quantization unit 154 may determine a quantization parameter for a TU as the sum of a predicted quantization parameter value and a delta quantization parameter value. However, inverse quantization unit 154 may determine quantization groups of coefficient blocks having the same quantization parameter delta value to further reduce quantization parameter delta value signaling overhead.

In examples in accordance with the sub-QG aspect of this disclosure, entropy decoding unit 150 may decode one or more sub-QGs based on syntax elements in a parameter set, such as a PPS or SPS. The sub-QG may comprise a block of samples within a quantization group or as a block of samples within a CU having dimensions larger than or equal to the QG size. Each sub-QG represents a specific region that has the same quantization parameter delta value. By limiting the size of the sub-QG, deblocking delay introduced by having to back-propagate a QP value of a block may be reduced.

Entropy decoding unit 150 may supply values of syntax elements related to sub-QGs to prediction processing unit 152 and to inverse quantization unit 154. Inverse quantization unit 154 may determine the size of a sub-QG based on syntax elements in the PPS, SPS, slice header, etc., received from entropy decoding unit 150. The size of the sub-QG may be equal to an 8×8 block of samples in some examples. In other examples, the size of the sub-QG may be the maximum size of either an 8×8 block of samples or the minimum TU size, though other sub-QG sizes may be possible. Inverse quantization unit 154 may also determine an upper bound on the size of a sub-QG, which may be the size of quantization group in which the sub-QG is located. Alternatively, if the sub-QG is located within a CU having dimensions larger than the size of a QG, inverse quantization unit 154 may determine that the upper bound of the sub-QG is the size of the CU.

Inverse quantization unit 154 may further determine the location in x-y coordinates of a sub-QG based on syntax element values from the SPS, PPS, slice header, etc. In accordance with this aspect, inverse quantization unit 154 may determine the location of the sub-QG as (n*the sub-QG size, m*the sub-QG size), where n and m are natural numbers.

Once inverse quantization unit 154 has determined the position, size, etc. of a sub-QG, inverse quantization unit 154 may reconstruct the quantization parameter for the sub-QG as the sum of a predicted quantization parameter and a quantization parameter delta for the sub-QG. Inverse quantization unit may then apply inverse quantization to the blocks comprising the sub-QG using the reconstructed quantization parameter. Inverse quantization unit 154 may also apply the quantization parameter used to reconstruct the blocks of one sub-QG to reconstruct blocks a subsequent sub-QG within the same CU or QG.

After inverse quantization unit 154 inverse quantizes a transform coefficient block, inverse transform processing unit 156 may generate a residual video block for the TU associated with the transform coefficient block. Inverse transform processing unit 156 may apply an inverse transform to the transform coefficient block in order to generate the residual video block for the TU. For example, inverse transform processing unit 156 may apply an inverse DCT, an inverse integer transform, an inverse Karhunen-Loeve transform (KLT), an inverse rotational transform, an inverse directional transform, or another inverse transform to the transform coefficient block.

In some examples, inverse transform processing unit 156 may determine an inverse transform to apply to the transform coefficient block based on signaling from video encoder 20. In such examples, inverse transform processing unit 156 may determine the inverse transform based on a signaled transform at the root node of a quadtree for a treeblock associated with the transform coefficient block. In other examples, inverse transform processing unit 156 may infer the inverse transform from one or more coding characteristics, such as block size, coding mode, or the like. In some examples, inverse transform processing unit 156 may apply a cascaded inverse transform.

Within a CU, entropy decoding unit 150 may decode syntax elements related to various aspects of the techniques of this disclosure. For example, if entropy decoding unit 150 receives a bitstream in accordance with a no_residual_syntax_flag aspect of this disclosure, entropy decoding unit 150 may decode a no_residual_syntax_flag syntax element of the CU in some cases. In various examples, entropy decoduing unit 150 may decode the no_residual_syntax flag from an encoded video bitstream using CABAC, and more specifically using at least one of a joined CABAC context and a separate CABAC context.

Based on the value of the no_residual_syntax flag element, prediction processing unit 152 may determine whether a quantization parameter delta value is coded in the CU.

For example, if the no_residual_syntax_flag value is equal to zero, entropy coding unit 150 may decode the quantization parameter delta value from the CU, and supply the quantization parameter delta value to inverse quantization unit 154. Inverse quantization unit 154 may determine a quantization group comprising one or more sample blocks of the CU, and may derive the quantization parameters for the blocks based on the quantization parameter delta value signaled in the CU.

Decoding the quantization parameter delta value from the CU may also allow video decoder 30 to determine the quantization parameter delta value from an encoded video bitstream If the no_residual_syntax_flag is equal to one, entropy decoding unit 150 may determine that no quantization parameter delta value is signaled in the CU, and may not supply the quantization parameter delta value to inverse quantization unit 154 from the CU or TUs of the CU.

In additional examples in accordance with this aspect of the disclosure, entropy decoding unit 150 may be further configured to derive coded block flag values of sample blocks of the CU based on the no_residual_syntax_flag value. For example, if the no_residual_syntax_flag is equal to one, then entropy decoding unit 150 may determine that all cbf flags of blocks of the CU are equal to zero. Decoding unit 150 may supply the information about the cbf flags being all equal to zero to prediction processing unit 152 and to inverse transform processing unit 156 so that inverse transform processing unit 156 can reconstruct the sample blocks of video data of the CU after inverse quantization unit 154 performs inverse quantization.

In examples in accordance with the split transform flag aspect of this disclosure, entropy decoding unit 150 may determine whether a subsequent level of a transform tree is coded beneath a current level of a transform tree based on the value of a split_tranform_flag syntax element within the current level of the transform tree. As discussed above, the techniques of this disclosure may prohibit or disallow a video encoder, such as video encoder 20 from signaling a split transform flag having a value equal to one if all cbf flags of blocks of the next level of the transform tree are equal to zero, i.e. there are no transform coefficients for any of the blocks of the next level of the transform tree. Reciprocally, entropy decoding unit 150 may determine that a next level of a transform tree is not coded if the split transform flag is equal to zero for the current level of the transform tree and that all blocks of the next level of the transform tree have a cbf equal to zero, i.e. do not have residual transform coefficients.

Additionally, in some examples of this aspect, entropy decoding unit 150 may decode the value of the quantization parameter delta value for the transform tree if the split transform flag is equal to one. Inverse quantization unit 154 may receive the quantization parameter delta value from entropy decoding unit 150 and perform inverse quantization on the blocks of a quantization group based on the quantization parameter delta value determine from the transform tree.

If a PU of the CU was encoded using inter prediction, motion compensation unit 162 may perform motion compensation to generate a predicted video block for the PU. Motion compensation unit 162 may use motion information for the PU to identify a reference block for the PU. The reference block of a PU may be in a different temporal picture than the PU. The motion information for the PU may include a motion vector, a reference picture index, and a prediction direction. Motion compensation unit 162 may use the reference block for the PU to generate the predicted video block for the PU. In some examples, motion compensation unit 162 may predict the motion information for the PU based on motion information of PUs that neighbor the PU. In this disclosure, a PU is an inter-predicted PU if video encoder 20 uses inter prediction to generate the predicted video block of the PU.

In some examples, motion compensation unit 162 may refine the predicted video block of a PU by performing interpolation based on interpolation filters. Identifiers for interpolation filters to be used for motion compensation with sub-sample precision may be included in the syntax elements. Motion compensation unit 162 may use the same interpolation filters used by video encoder 20 during generation of the predicted video block of the PU to calculate interpolated values for sub-integer samples of a reference block. Motion compensation unit 162 may determine the interpolation filters used by video encoder 20 according to received syntax information and use the interpolation filters to produce the predicted video block.

If a PU is encoded using intra prediction, intra prediction processing unit 164 may perform intra prediction to generate a predicted video block for the PU. For example, intra prediction processing unit 164 may determine an intra prediction mode for the PU based on syntax elements in the bitstream. The bitstream may include syntax elements that intra prediction processing unit 164 may use to predict the intra prediction mode of the PU.

In some instances, the syntax elements may indicate that intra prediction processing unit 164 is to use the intra prediction mode of another PU to predict the intra prediction mode of the current PU. For example, it may be probable that the intra prediction mode of the current PU is the same as the intra prediction mode of a neighboring PU. In other words, the intra prediction mode of the neighboring PU may be the most probable mode for the current PU. Hence, in this example, the bitstream may include a small syntax element that indicates that the intra prediction mode of the PU is the same as the intra prediction mode of the neighboring PU. Intra prediction processing unit 164 may then use the intra prediction mode to generate prediction data (e.g., predicted samples) for the PU based on the video blocks of spatially neighboring PUs.

Reconstruction unit 158 may use the residual video blocks associated with TUs of a CU and the predicted video blocks of the PUs of the CU, i.e., either intra-prediction data or inter-prediction data, as applicable, to reconstruct the video block of the CU. Thus, video decoder 30 may generate a predicted video block and a residual video block based on syntax elements in the bitstream and may generate a video block based on the predicted video block and the residual video block.

After reconstruction unit 158 reconstructs the video block of the CU, filter unit 159 may perform a deblocking operation to reduce blocking artifacts associated with the CU. In addition, filter unit 159 may remove the offset introduced by the encoder and perform a filtering operation that is the inverse of the operation performed by the encoder. After filter unit 159 performs these operations, video decoder 30 may store the video block of the CU in decoded picture buffer 160. Decoded picture buffer 160 may provide reference pictures for subsequent motion compensation, intra prediction, and presentation on a display device, such as display device 32 of FIG. 1. For instance, video decoder 30 may perform, based on the video blocks in decoded picture buffer 160, intra prediction or inter prediction operations on PUs of other CUs.

In this manner, video decoder 30 of FIG. 3 represents an example of a video decoder configured to implement various aspects or combinations thereof of the techniques described in this disclosure. For example, in a first aspect, video decoder 30 may decode a quantization parameter delta value in a coding unit (CU) of the video data before decoding a version of a block of the CU in a bitstream so as to facilitate deblocking filtering.

In an example of a second aspect of the techniques of this disclosure, video decoder 30 may be configured to determine a sub-quantization group, wherein the sub-quantization group comprises 1) a block of samples within a quantization group or 2) a block within a video block with dimensions larger than or equal to a size of the quantization group, and perform quantization with respect to the determined sub-quantization group.

In an example of a third aspect of the techniques of this disclosure, video decoder 30 may determine whether one or more coded block flags, which indicate whether there are any residual transform coefficients in a block of video data, are equal to zero within blocks of video data of a transform tree based on a split transform flag; and decode a transform tree for the blocks of video data based on the determination.

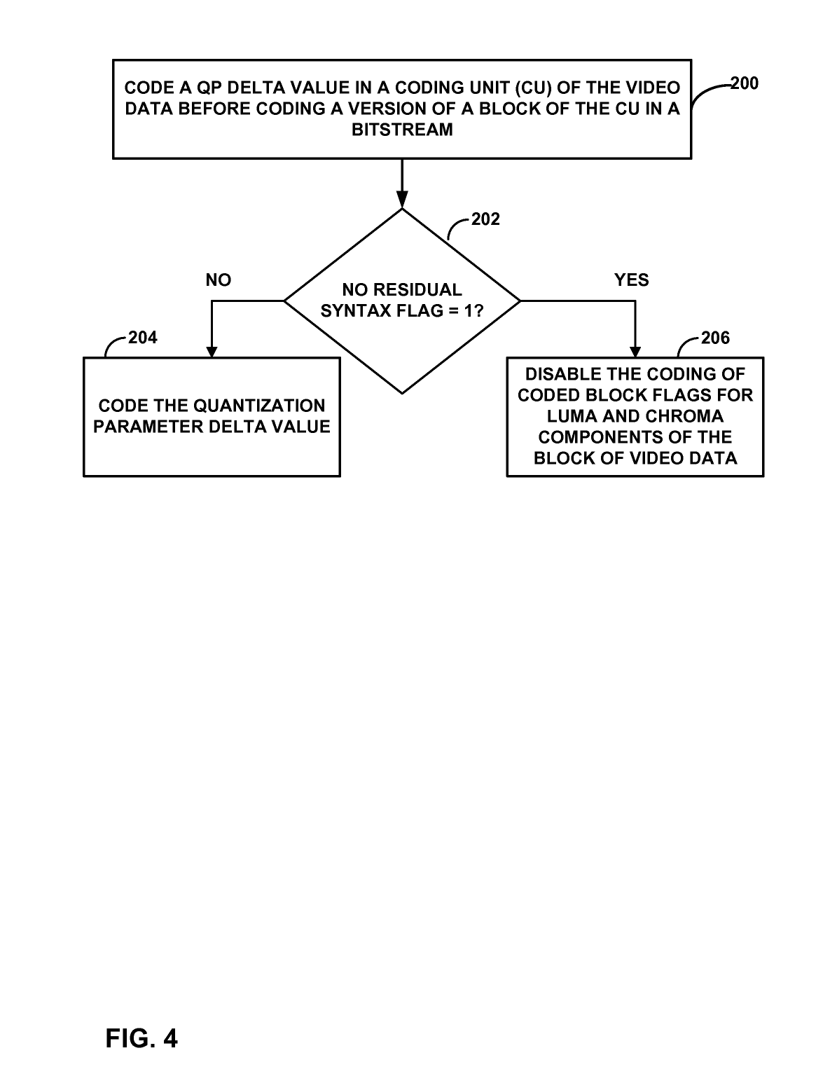

FIG. 4 is a flowchart illustrating a method for reducing deblocking delay in accordance with an aspect of this disclosure. For the purposes of illustration only, the method of FIG. 4 may be performed by a video coder, such as video encoder 20 or video decoder 30 illustrated in FIGS. 1-3.

In the method of FIG. 4, quantization unit 106 of video encoder 20 or inverse quantization unit 154 of video decoder 30 may be configured to code a quantization parameter delta value in a coding unit (CU) of video data before coding a version of a block of the CU in a bitstream so as to facilitate deblocking filtering. The CU may also include a no residual syntax flag in some examples. If the no residual syntax flag is not equal to one (“NO” branch of decision block 202), quantization unit 106 or inverse quantization unit 154 may be configured to code the quantization parameter delta value for the block of video data (204). If the no residual syntax flag is equal to one (“YES” branch of decision block 202), prediction processing unit 100 of video encoder 20 or prediction processing unit 152 of video decoder 30 may be configured to disable the coding of coded block flags for luma and chroma components of the block of video data (206).

In various examples, prediction processing unit 100 or prediction processing unit 152 may be configured to intra-code the block of video data to generate the coded version of the block of video data, and entropy decoding unit of video decoder 30 or entropy encoding unit 116 of video encoder 20 may further be configured to code the no residual syntax flag in the bitstream when the block of video data is intra-coded. In some examples, the method of FIG. 4 may further comprise performing deblocking filtering on the block of the CU.

In various examples, prediction processing unit 100 or prediction processing unit 152 or may determine that there are no coded block flags for luma and chroma components of the block of video data when the no_residual_syntax_flag that indicates whether no blocks of the CU have residual transform coefficients, is equal to one.

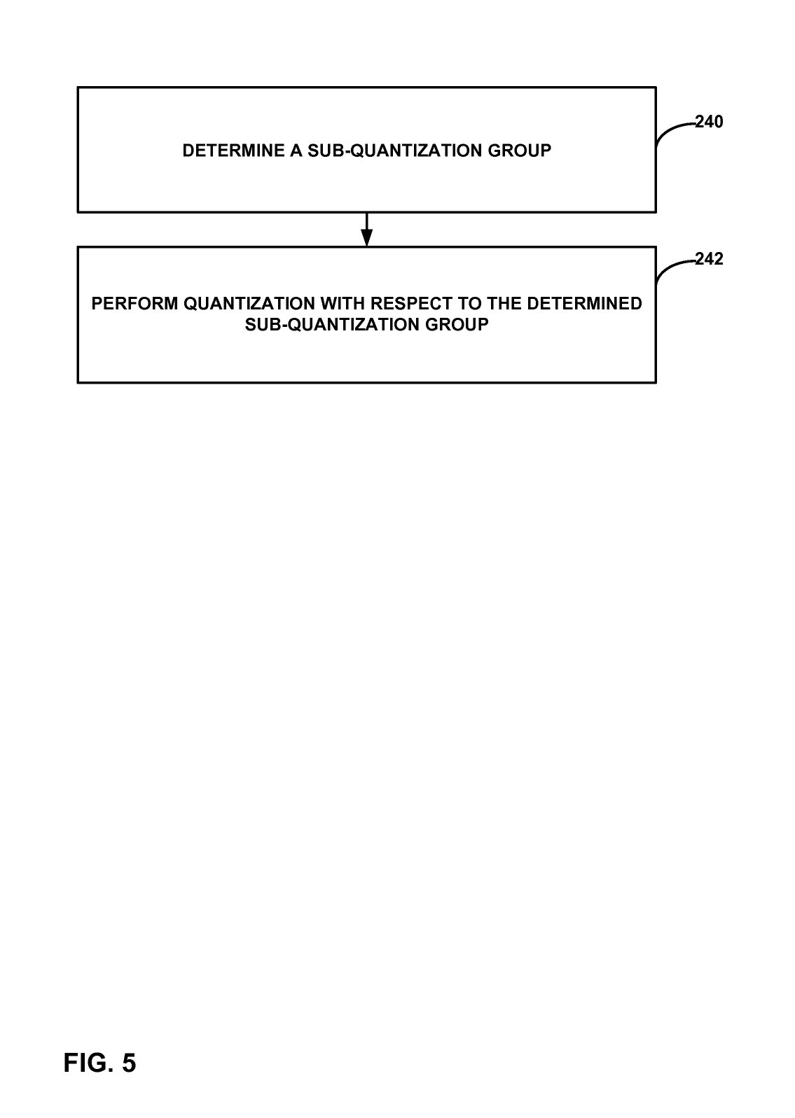

FIG. 5 is a flowchart illustrating a method for reducing deblocking delay in accordance with another aspect of this disclosure. For the purposes of illustration only, the method of FIG. 5 may be performed by a video coder, such as video encoder 20 or video decoder 30 illustrated in FIGS. 1-3.

In the method of FIG. 5, quantization unit 106 of video encoder 20 or inverse quantization unit 154 of video decoder 30 may be configured to determine a sub-quantization group. The sub-quantization group may comprise one of a block of samples within a quantization group, and a block of samples within a video block with dimensions larger than or equal to a size of the quantization group (240). Quantization unit 106 or inverse quantization unit 154 may be further configured to perform quantization with respect to the determined sub-quantization group (242).

In various examples, the size of the sub-quantization group may be equal to an 8×8 block of samples or determined by a maximum of an 8×8 block and a minimum transform unit size applied to the video block. The size of the sub-quantization group may also have an upper bound equal to either the size of the quantization group or, when the sub-quantization group is located within the block of video data with dimensions larger than the size of the quantization group, a size of the block of video data.

In other examples of this aspect of the techniques of this disclosure, the location of the sub-quantization group within a picture in which the block of video data resides may be restricted to an x-coordinate computed as a result of multiplying a variable n times the size of the sub-quantization group and a y-coordinate computed as a result of multiplying a variable m times the size of the sub-quantization group (n*subQGsize, m*subQGsize). The size of the sub-quantization group may be specified, e.g. by quantization unit 106 or inverse quantization unit 154, in one or more of a sequence parameter set, a picture parameter set, and a slice header.

In the method of FIG. 5 quantization unit 106 or inverse quantization unit 154 may also be further configured to identify a delta quantization parameter value, determine a quantization parameter based on the delta quantization parameter value, and apply the quantization parameter value to perform inverse quantization with respect to the sub-quantization group and any subsequent sub-quantization groups that follow the sub-quantization group within the same quantization group. Filter unit 113 of FIG. 2 or filter unit 159 of FIG. 3 may be further configured to perform deblocking filtering on the inversely quantized sub-quantization group.

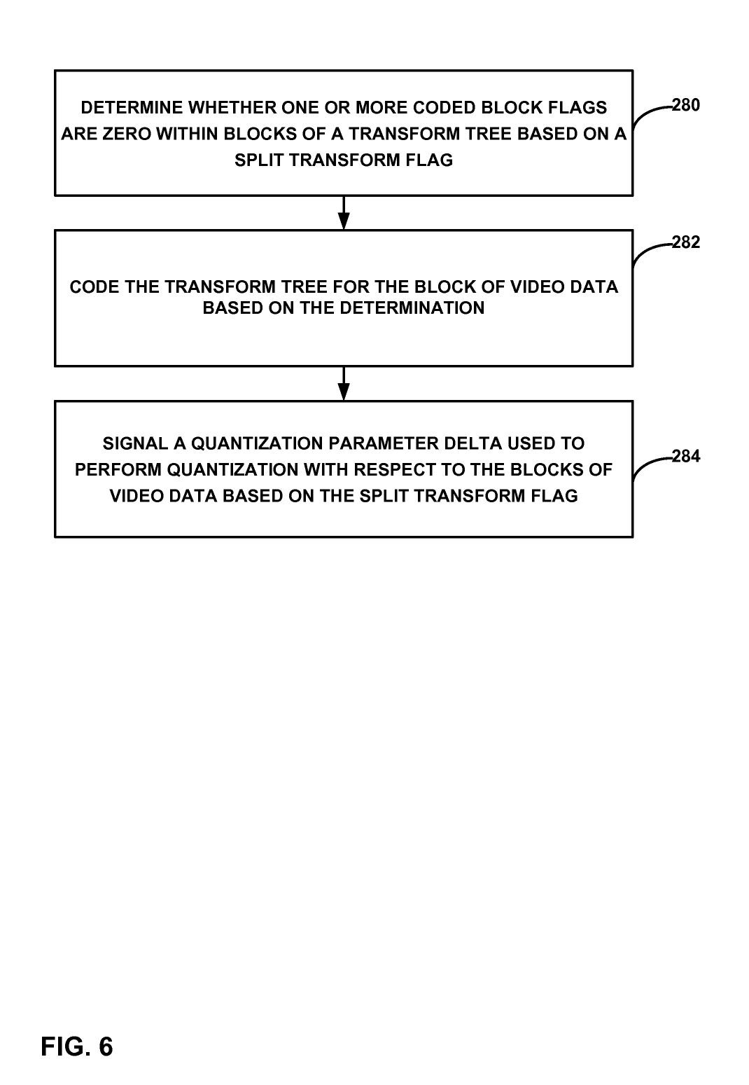

FIG. 6 is a flowchart illustrating a method for reducing deblocking delay in accordance with another aspect of this disclosure. For the purposes of illustration only, the method of FIG. 6 may be performed by a video coder, such as video encoder 20 or video decoder 30 illustrated in FIGS. 1-3. In the method of FIG. 6, prediction processing unit 100 of video encoder 20 or prediction processing unit 152 of video decoder 30 may determine whether one or more coded block flags, which indicate whether there are any non-zero residual transform coefficients in a block of video data, are equal to zero within blocks of video data of a transform tree based on a split transform flag (280), and code the transform tree for the blocks of video data based on the determination (282).

In various examples, in the method of FIG. 6, quantization unit 106 of video encoder 20 or inverse quantization unit 154 of video decoder 30 may be further configured to signal a quantization parameter delta used to perform quantization with respect to the block of video data base don the split transform flag (284).

In some examples, prediction processing unit 100 or prediction processing unit 152 may be configured to code the transform tree in response to the determination that one or more coded block flags are not zero within the block of video data based on the split transform flag.

In some examples, the method of FIG. 6 may further comprise coding a quantization parameter delta value used to perform quantization with respect to the blocks of video data based on the split transform flag. Filter unit 113 of video encoder 20 or filter unit 159 of video decoder 30 may further inversely quantize the blocks of video data based on the quantization parameter delta value, and performing deblocking filtering on the inversely quantized blocks of video data.

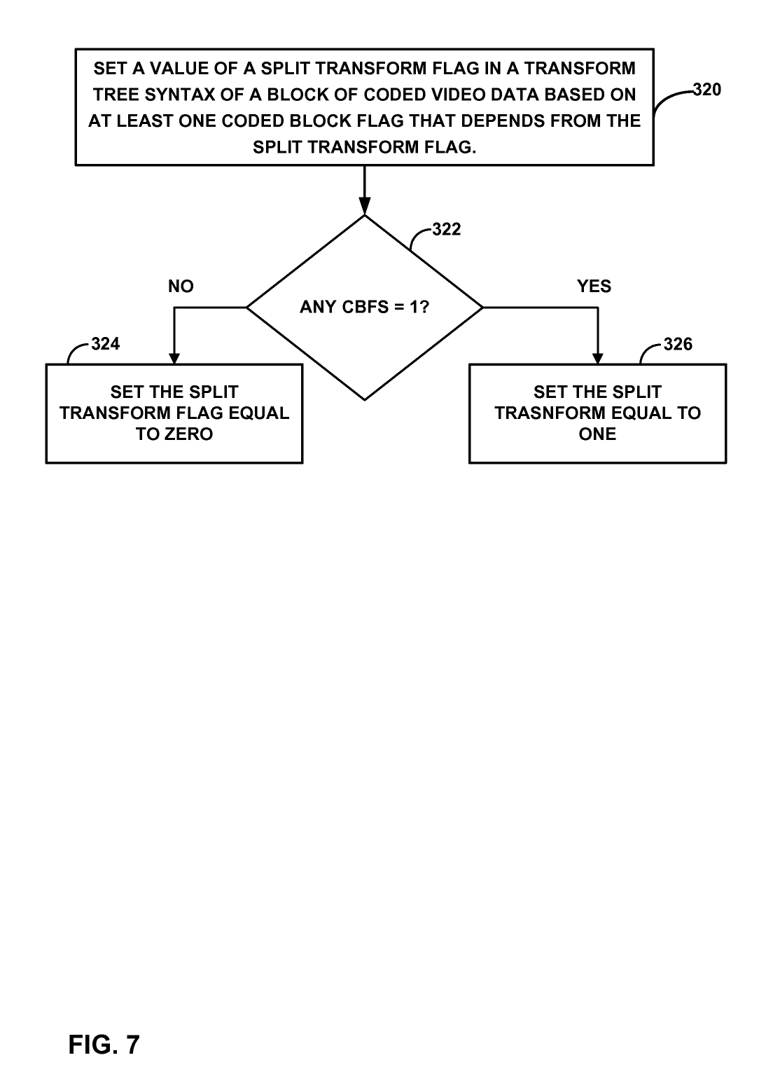

FIG. 7 is a flowchart illustrating a method for reducing deblocking delay in accordance with another aspect of this disclosure. For the purposes of illustration only, the method of FIG. 7 may be performed by a video coder, such as video encoder 20 illustrated in FIGS. 1-2. In the method of FIG. 7, prediction processing unit 100 may set a value of a split transform flag in a transform tree syntax block of a block of coded video data based on at least one coded video block flag that depends from the split transform flag (320). Filter unit 113 of video encoder 20 or filter unit 159 of video decoder 30 may further perform deblocking filtering on the block of coded video data.

Prediction processing unit 100 may determine whether any coded block flags that depend from the split transform flag are equal to one. If none of the coded block flags are equal to one (“NO” branch of decision block 322), prediction processing unit 100 may set the split transform flag equal to zero (324). If at least one of the coded block flags are equal to one (“YES” branch of decision block 322), prediction processing unit 100 may set the split transform flag equal to one.

It is to be recognized that in various examples, coding may comprise encoding by video encoder 20, and coding a version of the block comprises encoding, by video encoder 20, a version of the block. In other examples, coding may comprise decoding by video decoder 30, and decoding a version of the block may comprise decoding, by video decoder 30, a version of the block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software units configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, units, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding video data, the method comprising:
encoding a quantization parameter delta value in a coding unit (CU) of the video data before encoding a version of a block of the CU in a bitstream, so as to facilitate deblocking filtering.

2. The method of claim 1, further comprising intra-coding the block of video data to generate the encoded version of the block of the CU.

3. The method of claim 1, wherein encoding the quantization parameter delta value comprises encoding the quantization parameter delta value when a no_residual_syntax_flag that indicates whether no blocks of the CU have residual transform coefficients, is equal to zero.

4. The method of claim 3, further comprising encoding the no_residual_syntax_flag in the bitstream when the block of the CU is intra-coded.

5. The method of claim 1, further comprising performing deblocking filtering on the block of the CU.

6. The method of claim 1, further comprising disabling the encoding of coded block flags for luma and chroma components of the block of the CU when a no_residual_syntax_flag that indicates whether no blocks of the CU have residual transform coefficients, is equal to one.

7. The method of claim 6, further comprising determining that there are no coded block flags for luma and chroma components of the block of video data when the no_residual_syntax_flag that indicates whether no blocks of the CU have residual transform coefficients, is equal to one.

8. A method of decoding video data, the method comprising:
decoding a quantization parameter delta value in a coding unit (CU) of the video data before decoding a version of a block of the CU in a bitstream, so as to facilitate deblocking filtering.

9. The method of claim 8, further comprising intra-coding the block of video data to generate the decoded version of the block of the CU.

10. The method of claim 8, wherein decoding the quantization parameter delta value comprises decoding the quantization parameter delta value when a no_residual_syntax_flag that indicates whether no blocks of the CU have residual transform coefficients, is equal to zero.

11. The method of claim 10, further comprising decoding the no_residual_syntax_flag in the bitstream when the block of the CU is intra-coded.

12. The method of claim 8, further comprising performing deblocking filtering on the block of the CU.

13. The method of claim 8, further comprising disabling the decoding of coded block flags for luma and chroma components of the block of the CU when a no_residual_syntax_flag that indicates whether no blocks of the CU have residual transform coefficients, is equal to one.

14. The method of claim 13, further comprising determining that there are no coded block flags for luma and chroma components of the block of video data when the no_residual_syntax_flag that indicates whether no blocks of the CU have residual transform coefficients, is equal to one.

15. A device configured to code video data, the device comprising:
a memory; and
at least one processor, wherein the at least one processor is configured to:
code a quantization parameter delta value in a coding unit (CU) of the video data before coding a version of a block of the CU in a bitstream, so as to facilitate deblocking filtering.

16. The device of claim 15, wherein the at least one processor is further configured to intra-code the block of video data to generate the coded version of the block of the CU.

17. The device of claim 15, wherein to code the quantization parameter delta value, the at least one processor is further configured to code the quantization parameter delta value when a no_residual_syntax_flag that indicates whether no blocks of the CU have residual transform coefficients, is equal to zero.

18. The device of claim 17, wherein the at least one processor is further configured to code the no_residual_syntax_flag in the bitstream when the block of the CU is intra-coded.

19. The device of claim 15, wherein the at least one processor is further configured to perform deblocking filtering on the block of the CU.

20. The device of claim 15, wherein the at least one processor is further configured to disable the coding of coded block flags for luma and chroma components of the block of the CU when a no_residual_syntax_flag that indicates whether no blocks of the CU have residual transform coefficients, is equal to one.

21. The device of claim 20, wherein the at least one processor is further configured to determine there are no coded block flags for luma and chroma components of the block of video data when the no_residual_syntax_flag that indicates whether no blocks of the CU have residual transform coefficients, is equal to one.

22. A device for coding video, the device comprising:
means for encoding a quantization parameter delta value in a coding unit (CU) of the video data before encoding a version of a block of the CU in a bitstream, so as to facilitate deblocking filtering; and
means for performing deblocking filtering on the block of the CU.

23. A non-transitory computer-readable storage medium comprising instructions that, when executed by at least one processor, cause the at least one processor to:
encode a quantization parameter delta value in a coding unit (CU) of the video data before encoding a version of a block of the CU in a bitstream, so as to facilitate deblocking filtering.

24. A method of encoding video, the method comprising:
determining a sub-quantization group, wherein the sub-quantization group comprises one of a block of samples within a quantization group, and a block of samples within a video block with dimensions larger than or equal to a size of the quantization group; and
performing quantization with respect to the determined sub-quantization group.

25. The method of claim 24, wherein the size of the sub-quantization group is equal to an 8×8 block of samples.

26. The method of claim 24, wherein the size of the sub-quantization group is determined by a maximum of an 8×8 block and a minimum transform unit size applied to the video block.

27. The method of claim 24, wherein the sub-quantization group has an upper bound for the size of sub-quantization group equal to either the size of the quantization group or, when the sub-quantization group is located within the block of video data with dimensions larger than the size of the quantization group, a size of the block of video data.

28. The method of claim 24, wherein a location of the sub-quantization group within a picture in which the block of video data resides is restricted to an x-coordinate computed as a result of multiplying a variable n times the size of the sub-quantization group and a y-coordinate computed as a result of multiplying a variable m times the size of the sub-quantization group (n*subQGsize, m*subQGsize).

29. The method of claim 24, further comprising encoding the size of the sub-quantization group in one or more of a sequence parameter set, a picture parameter set, and a slice header.

30. The method of claim 24, wherein performing quantization comprises:
identifying a delta quantization parameter value;
determining a quantization parameter based on the delta quantization parameter value; and
applying the quantization parameter value to perform inverse quantization with respect to the sub-quantization group and any subsequent sub-quantization groups that follow the sub-quantization group within the same quantization group.

31. The method of claim 24, further comprising:
performing deblocking filtering on the inversely quantized sub-quantization group.

32. A method of decoding video, the method comprising:
determining a sub-quantization group, wherein the sub-quantization group comprises one of a block of samples within a quantization group, and a block of samples within a video block with dimensions larger than or equal to a size of the quantization group; and
performing inverse quantization with respect to the determined sub-quantization group.

33. The method of claim 32, wherein the size of the sub-quantization group is equal to an 8×8 block of samples.

34. The method of claim 32, wherein the size of the sub-quantization group is determined by a maximum of an 8×8 block and a minimum transform unit size applied to the video block.

35. The method of claim 32, wherein the sub-quantization group has an upper bound for the size of sub-quantization group equal to either the size of the quantization group or, when the sub-quantization group is located within the block of video data with dimensions larger than the size of the quantization group, a size of the block of video data.

36. The method of claim 32, wherein a location of the sub-quantization group within a picture in which the block of video data resides is restricted to an x-coordinate computed as a result of multiplying a variable n times the size of the sub-quantization group and a y-coordinate computed as a result of multiplying a variable m times the size of the sub-quantization group (n*subQGsize, m*subQGsize).

37. The method of claim 32, further comprising encoding the size of the sub-quantization group in one or more of a sequence parameter set, a picture parameter set, and a slice header.

38. The method of claim 32, wherein performing inverse quantization comprises:
identifying a delta quantization parameter value;
determining a quantization parameter based on the delta quantization parameter value; and
applying the quantization parameter value to perform inverse quantization with respect to the sub-quantization group and any subsequent sub-quantization groups that follow the sub-quantization group within the same quantization group.

39. The method of claim 32, further comprising:
performing deblocking filtering on the inversely quantized determined sub-quantization group.

40. A device configured to code video data, the device comprising:
a memory; and
at least one processor, wherein the at least one processor is configured to:
determine a sub-quantization group, wherein the sub-quantization group comprises one of a block of samples within a quantization group, and a block of samples within a video block with dimensions larger than or equal to a size of the quantization group; and
perform inverse quantization with respect to the determined sub-quantization group.

41. The device of claim 40, wherein the size of the sub-quantization group is equal to an 8×8 block of samples.

42. The device of claim 40, wherein the size of the sub-quantization group is determined by a maximum of an 8×8 block and a minimum transform unit size applied to the video block.

43. The device of claim 40, wherein the sub-quantization group has an upper bound for the size of sub-quantization group equal to either the size of the quantization group or, when the sub-quantization group is located within the block of video data with dimensions larger than the size of the quantization group, a size of the block of video data.

44. The device of claim 40, wherein a location of the sub-quantization group within a picture in which the block of video data resides is restricted to an x-coordinate computed as a result of multiplying a variable n times the size of the sub-quantization group and a y-coordinate computed as a result of multiplying a variable m times the size of the sub-quantization group (n*subQGsize, m*subQGsize).

45. The device of claim 40, wherein the at least one processor is further configured to code the size of the sub-quantization group in one or more of a sequence parameter set, a picture parameter set, and a slice header.

46. The device of claim 40, wherein to perform inverse quantization, the at least one processor is further configured to:
identify a delta quantization parameter value;
determine a quantization parameter based on the delta quantization parameter value; and
apply the quantization parameter value to perform inverse quantization with respect to the sub-quantization group and any subsequent sub-quantization groups that follow the sub-quantization group within the same quantization group.

47. The device of claim 40, wherein the at least one processor is further configured to:
perform deblocking filtering on the inversely quantized determined sub-quantization group.

48. A device for coding video, the device comprising:
means for determining a sub-quantization group, wherein the sub-quantization group comprises one of a block of samples within a quantization group, and a block of samples within a video block with dimensions larger than or equal to a size of the quantization group; and
means for performing inverse quantization with respect to the determined sub-quantization group.

49. A non-transitory computer-readable storage medium comprising instructions that, when executed by at least one processor, cause the at least one processor to:
determine a sub-quantization group, wherein the sub-quantization group comprises one of a block of samples within a quantization group, and a block of samples within a video block with dimensions larger than or equal to a size of the quantization group; and
perform inverse quantization with respect to the determined sub-quantization group.

50. A method of encoding video, the method comprising:
determining whether one or more coded block flags, which indicate whether there are any non-zero residual transform coefficients in a block of video data, are equal to zero within blocks of video data of a transform tree based on a split transform flag; and
encoding the transform tree for the blocks of video data based on the determination.

51. The method of claim 50, wherein encoding the transform tree comprises encoding the transform tree in response to the determination that the one or more coded block flags are not equal to zero within the blocks of the transform tree based on the split transform flag.

52. The method of claim 50, further comprising signaling a quantization parameter delta value used to perform quantization with respect to the blocks of video data based on the split transform flag.

53. The method of claim 52, further comprising:
inversely quantizing the blocks of video data based on the quantization parameter delta value; and
performing deblocking filtering on the inversely quantized blocks of video data.

54. A method of decoding video, the method comprising:
determining whether one or more coded block flags, which indicate whether there are any residual transform coefficients in a block of video data, are equal to zero within blocks of video data of a transform tree based on a split transform flag; and
decoding the transform tree for the blocks of video data based on the determination.

55. The method of claim 54, wherein decoding the transform tree comprises decoding the transform tree in response to the determination that one or more coded block flags are not zero within the blocks of the transform tree based on the split transform flag.

56. The method of claim 54, further comprising decoding a quantization parameter delta value used to perform inverse quantization with respect to the blocks of video data based on the split transform flag.

57. The method of claim 56, further comprising:
inversely quantizing the blocks of video data based on the quantization parameter delta value; and
performing deblocking filtering on the inversely quantized blocks of video data.

58. A device configured to code video data, the device comprising:
a memory; and
at least one processor, wherein the at least one processor is configured to:
determine whether one or more coded block flags, which indicate whether there are any residual transform coefficients in a block of video data, are equal to zero within blocks of video data of a transform tree based on a split transform flag; and
code the transform tree for the blocks of video data based on the determination.

59. The device of claim 58, wherein to decode the transform tree, the at least one processor is configured to:
code the transform tree in response to the determination that one or more coded block flags are not zero within the blocks of the transform tree based on the split transform flag.

60. The device of claim 58, wherein the at least one processor is father configured to:
code a quantization parameter delta value used to perform inverse quantization with respect to the blocks of video data based on the split transform flag.

61. The device of claim 60, wherein the at least one processor is further configured to:
inversely quantize the blocks of video data based on the quantization parameter delta value; and
perform deblocking filtering on the inversely quantized blocks of video data.

62. A device configured to code video data, the device comprising:
means for determining whether one or more coded block flags, which indicate whether there are any residual transform coefficients in a block of video data, are equal to zero within blocks of video data of a transform tree based on a split transform flag; and
means for coding the transform tree for the blocks of video data based on the determination.

63. A non-transitory computer-readable storage medium comprising instructions that, when executed by at least one processor, cause the at least one processor to:
determine whether one or more coded block flags, which indicate whether there are any residual transform coefficients in a block of video data, are equal to zero within blocks of video data of a transform tree based on a split transform flag; and
code the transform tree for the blocks of video data based on the determination.

64. A method of encoding video data, the method comprising:
setting a value of a split transform flag in a transform tree syntax of a block of coded video data based on at least one coded block flag that depends from the split transform flag.

65. The method of claim 64, wherein setting the split transform flag comprises setting the split transform flag equal to one when the at least one coded block flag that depends from the split transform flag is equal to one.

66. The method of claim 64, wherein setting the split transform flag comprises setting the split transform flag equal to zero when all of the at least one of the coded block flags that depend from the split transform flag are equal to zero.

67. The method of claim 64, further comprising:
performing deblocking filtering on the block of coded video data.

68. A device for encoding video, the device comprising:
a memory; and
at least one processor, wherein the at least one processor is configured to:
set a value of a split transform flag in a transform tree syntax of a block of coded video data based on at least one coded block flag that depends from the split transform flag.

69. The device of claim 68, wherein to set the split transform flag, the at least one processor is configured to set the split transform flag equal to one when the at least one coded block flag that depends from the split transform flag is equal to one.

70. The device of claim 68, wherein to set the split transform flag, the at least one processor is configured to set the split transform flag equal to zero when all of the at least one of the coded block flags that depend from the split transform flag are equal to zero.

71. The device of claim 68, wherein the at least one processor is further configured to:
perform deblocking filtering on the block of coded video data.

72. A device for encoding video, the device comprising:
means for setting a value of a split transform flag in a transform tree syntax of a block of coded video data based on at least one coded block flag that depends from the split transform flag; and
means for performing deblocking filtering on the block of coded video data.

73. A non-transitory computer-readable storage medium comprising instructions that, when executed by at least one processor, cause the at least one processor to:
set a value of a split transform flag in a transform tree syntax of a block of coded video data based on at least one coded block flag that depends from the split transform flag.
